(19) United States
(12) Patent Application Publication
(10) Pub. No.: US 2015/0242406 A1
(43) Pub. Date: Aug. 27, 2015

(54) METHOD AND SYSTEM FOR SYNCHRONIZING, ORGANIZING AND RANKING CONTACTS IN AN ELECTRONIC DEVICE

(71) Applicant: Samsung Electronics Co., Ltd., Suwon-si (KR)

(72) Inventors: Satnam SINGH, Bangalore (IN); Gaurav kumar JAIN, Bangalore (IN); Prudhvi KOSARAJU, Bangalore (IN); Girish KULKARNI, Bangalore (IN)

(21) Appl. No.: 14/628,697

(22) Filed: Feb. 23, 2015

(30) Foreign Application Priority Data
Feb. 24, 2014 (IN) 917/CHE/2014

(51) Int. Cl. G06F 17/30

(52) U.S. Cl. CPC G06F 17/3053; G06F 17/30864; G06F 17/30575

(57) ABSTRACT

A method and a system for synching, organizing, and ranking user contacts by obtaining user contacts profile from various data sources are provided. The method includes identifying at least one data item associated with each contact from the plurality of data sources, wherein each data item comprises at least one of an attribute, and a sub-attribute, and computing a degree of similarity between each contact of the user and each other contact of the user using the at least one identified data item.

### CROSS-REFERENCE TO RELATED APPLICATION(S)

This application claims the benefit under 35 U.S.C. §119(a) of an Indian patent application filed on Feb. 24, 2014 in the Indian Intellectual Property Office and assigned Serial number 917/CHE/2014, the entire disclosure of which is hereby incorporated by reference.

### TECHNICAL FIELD

The present disclosure relates to managing contacts associated with multiple platforms. More particularly, the present disclosure relates to a robust system and a method for effectively synchronizing, grouping, and ranking contacts associated with various data sources.

### BACKGROUND

Modern communication technologies have led to increasingly interconnected global population. Many users have a large number of social contacts (e.g., family, friends, acquaintances, partners, colleagues, club members, and the like) in their electronic devices, such as smart phones, tablets, or the like. Some of these contacts are available both on the electronic device and Social Network Sources (SNSs). However, although the contacts are the same, they are not paired or synchronized in the electronic device.

Systems and methods of the related art are used to perform pairing or syncing of contacts based on hard match of uniquely identified data fields, such as a mobile/phone number, an email ID, an Instant Messengers ID, and the like. The pairing or syncing of the same contacts is performed by matching textual data in the contacts profile, for example, a contact's name. The systems and method of the related art use limited data items of contacts profile data for pairing or syncing the contacts in the electronic devices. Further, due to non-availability of uniquely identified data fields, such as email ID's, phone numbers, Instant Messengers ID, many user contacts do not get synchronized in the systems and methods of the related art. Furthermore, systems and method of the related art are limited to hard match of uniquely identified data fields of the contact fields.

Furthermore, as the contacts in an address book of the electronic device may belong to different social groups, the management (i.e., grouping, organizing, ranking, and the like) of the contacts from different groups in the address book involves significant challenges. Systems and method of the related art may allow the user to manually create and maintain different groups of contact (e.g., family, colleague, classmate, hobbies group, and the like), which in itself is a tedious task and needs significant user time.

Furthermore, many users receive a plurality of social media updates from their contacts from various SNSs, whenever the electronic device is connected to the SNSs. The social media updates described herein include various social activities, such as, for example, but not limited to, sharing photos or videos, comments on posts or photos or videos, likes, sending or receiving emails, tweets, re-tweets, endorsements, recommendations, and the like. Generally, the user might not be interested in all the activities but, more interested in the activities associated with their preferred contacts.

Therefore, a need exists for a robust system and a method for effectively synchronizing, organizing, and ranking contacts associated with different data sources in smart devices.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and a system for pairing or synchronizing one or more contacts of a user obtained from one or more data sources. The synchronization of contacts is performed by using data items including attributes and sub-attributes of the contacts.

Another aspect of the present disclosure is to provide a method and a system for automatically organizing one or more contacts by creating a group of data items including one or more contacts. The groups or sub-groups are automatically created by comparing data item(s) of a device user's/owner's profile with data item(s) of one or more contacts profile.

Another aspect of the present disclosure is to provide a method and a system for ranking contacts based on activities performed by various users associated with different data sources over a period of time.

In accordance with an aspect of the present disclosure, a method for synchronizing one or more contacts associated with various data sources is provided. The method includes identifying data item(s) associated with each contact from various data sources, where each data item includes an attribute, a sub-attribute, and the like. Further, the method includes computing a degree of similarity for each contact using the identified data items. Furthermore, the method includes determining whether the degree of similarity associated with each contact exceeds a threshold and performing an action contacts associated with a user based on the degree of similarity.

In accordance with another aspect of the present disclosure, a method for automatically organizing contacts associated with various data sources is provided. The method includes identifying data item(s) associated with each contact from various data sources, where each data item includes an attribute, a sub-attribute, and the like. Further, the method includes computing a degree of similarity between the identified data item associated with the user (or owner) and other data items associated with the contact. Furthermore, the method includes determining whether the degree of similarity associated with each data item exceeds a threshold, and organizing the contact into a group (or sub-group) of data items in response to determining that the degree of similarity for each data item exceeds the threshold.

In accordance with another aspect of the present disclosure, a method for automatically ranking contacts associated with various data sources is provided. The method includes identifying an activity performed by the owner and associated contacts, and computing a degree of involvement of each contact based on the identified activity performed by the owner and the associated contacts over a time window. Further, the method includes ranking the contact in accordance to the computed degree of involvement.

In accordance with another aspect of the present disclosure, a system for synchronizing one or more contacts associated with various data sources is provided. The system includes an electronic device configured to include a synchronization module. The synchronization module is configured to identify data item(s) associated with each contact from various data sources, where each data item includes an attribute, a sub-attribute, and the like. Further, the synchronization module is configured to compute a degree of similarity for each contact using the identified data items. Furthermore, the synchronization module is configured to determine whether the degree of similarity associated with each contact exceeds a contact threshold and perform an action contacts associated with a user based on the degree of similarity.

In accordance with another aspect of the present disclosure, a system for automatically organizing contacts associated with various data sources is provided. The system includes an electronic device configured to include a grouping module. The grouping module is configured to identify data item(s) associated with each contact from various data sources, where each data item includes an attribute, a sub-attribute, and the like. Further, the grouping module is configured to compute a degree of similarity between the identified data item associated with the user (or owner) and other data items associated with the contact. Furthermore, the grouping module is configured to determine whether the degree of similarity associated with each data item exceeds a threshold, and organize the contact into a group (or sub-group) of data items in response to determining that the degree of similarity for each data item exceeds the threshold.

In accordance with another aspect of the present disclosure, a system for automatically ranking contacts associated with various data sources is provided. The system includes an electronic device configured to include ranking module configured to identify an activity performed by the owner and associated contacts, and compute a degree of involvement of each contact based on the identified activity performed by the owner and the associated contacts over a time window. Further, the ranking module is configured to rank the contact in accordance to the computed degree of involvement.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a block diagram of a system for managing contacts obtained from various data sources according to an embodiment of the present disclosure;

FIG. 2 illustrates an overview of obtaining and combining user contacts profile data from various data sources according to an embodiment of the present disclosure;

FIG. 3A illustrates a contribution of contact profile data according to an embodiment of the present disclosure;

FIG. 3B illustrates a contribution of data items according to an embodiment of the present disclosure;

FIG. 3C illustrates a contribution of attributes according to an embodiment of the present disclosure;

FIG. 4 illustrates contact profile data with various data items including attributes and sub-attributes according to an embodiment of the present disclosure;

FIG. 5 illustrates data items used for determining a degree of similarity according to an embodiment of the present disclosure;

FIG. 6 illustrates data items fusion according to an embodiment of the present disclosure;

FIG. 7 is a flow diagram illustrating a method for synchronizing contacts associated with various sources according to an embodiment of the present disclosure;

FIG. 8 is a flow diagram illustrating a method for synchronizing contact profiles obtained from various data sources by performing hard between contacts profile according to an embodiment of the present disclosure;

FIGS. 9A and 9B are flow diagrams illustrating a method for pairing or syncing one or more user contacts profile obtained from one or more sources using soft match between contacts profile data items according to an embodiment of the present disclosure;

FIG. 10 is a flow diagram illustrating a method for re-synchronizing contact profile according to an embodiment of the present disclosure;

FIG. 11 is a flow diagram illustrating a method for organizing the contact profiles into one or more groups according to an embodiment of the present disclosure;

FIG. 12 is a flow diagram illustrating a method for grouping one or more user using data items including attributes and sub-attributes contacts profile according to an embodiment of the present disclosure;

FIG. 13 is a flow diagram illustrating a method for organizing contact profiles into one or more groups according to an embodiment of the present disclosure;

FIG. 14 is a flow diagram illustrating a method for re-grouping updated at least one contact profile according to an embodiment of the present disclosure;

FIG. 15 is a flow diagram illustrating a method for text tokenization according to an embodiment of the present disclosure;

FIG. 16 is a flow diagram illustrating a text similarity method according to an embodiment of the present disclosure;

FIG. 17 illustrates an overview of obtaining social media updates and interaction data between owner and user contacts obtained from various data sources according to an embodiment of the present disclosure;

FIG. 18 is a flow diagram illustrating a method for organizing contact profiles into one or more groups according to an embodiment of the present disclosure;

FIG. 19 is a flow diagram illustrating a method for ranking contacts based on weighted activity scores according to an embodiment of the present disclosure;

FIGS. 20A, 20B, and 20C illustrate pairing contact profiles obtained from various data sources according to an embodiment of the present disclosure;

FIG. 21 illustrates groups of data items including contacts obtained from various data sources according to an embodiment of the present disclosure;

FIG. 22 illustrates activities displayed in accordance to ranks of a contact according to an embodiment of the present disclosure; and

FIG. 23 illustrates a computing environment implementing a method and a system for synchronizing, organizing, ranking contacts in an electronic device according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Prior to describing various embodiments of the present disclosure, it is useful to provide definitions for key terms and concepts used herein. Unless defined otherwise, all technical and scientific terms used herein have the same meaning as commonly understood by a personal having ordinary skill in the art to which this present disclosure belongs.

Data Items: May refers to an object or element associated with a data field of a contact profile concerning a specific property. The information associated with each data field can be broken down to various elementary data items. Each data item can be configured to include at least one of an attribute and sub-attribute.

Data item type: May refers to basic components of contacts profile. More particularly, the data item type defines the contents of a contact profile and information that is stored about the contact profile. The information in the data item types can include data items.

Priority data item type: May refers to data item type having highest priority. More particularly, data item type being regarded as more important than others in managing the contacts.

Degree of Similarity: May refers to a function which represents the (often exclusive) right to compute similarity, or exactness, and distance between data item(s) associated with a user with one or more data item(s) associated with other users.

Degree of involvement: May refers to a function which represents the (often exclusive) right to compute involvement of each user based on activities performed over a time window. More particularly, the degree of involvement may be used to numerically assess an activity strength performed by each contact over the time window.

Data sources: May refers to any source including contact profile information associated with a user. More particularly, the data sources may refers to the user electronic device data and any Social Network Sources (SNS) including the information about the contact profiles. Each data source can include contacts information associated with a user which may be directly stored or obtained from any other data source.

Various embodiments disclosed herein achieve a method and a system for managing (e.g., synchronizing, organizing, ranking, and the like) contacts of a user associated with various data sources. In an embodiment of the present disclosure, a method and a system for pairing or synchronizing one or more contacts associated with various data sources is described. The method includes identifying data item(s) associated with each contact from various data sources, where each data item includes an attribute, a sub-attribute, and the like. A degree of similarity for each contact can be computed using the identified data items. Unlike the system of the related art, the unique profile attributes and additional sub-attributes can be used to compute the degree of similarity, such as to enhance the accuracy of synchronization. For example, if a contact has employer organization as “Samsung” as a profile attribute, then the system and method also uses additional sub-attributes, such as employment start date, end dates, position in organization, working domain/area, and the like, to accurately identify and synchronize the same contacts. Further, the method includes determining whether the degree of similarity associated with each contact exceeds a contact threshold. Furthermore, the method includes automatically synchronizing contacts associated with a user based on the degree of similarity.

In an embodiment of the present disclosure, a system and a method for automatically organizing the contacts are described. The method includes identifying data item(s) associated with each contact from various data sources, where each data item includes an attribute, a sub-attribute, and the like. A degree of similarity can be computed between the identified data item associated with the user (or owner) and other data items associated with the contact. Further, the method includes determining whether the degree of similarity associated with each data item exceeds a threshold. Furthermore, the method includes organizing the contact into a group (or sub-group) of data items in response to determining that the degree of similarity for each data item exceeds the threshold. Unlike the system of the related art, the groups are automatically created without any user intervention. The users need not to use multiple applications to communicate with their contacts because all their communications are centered in one point. For example, the user can communicate with all the contact from different data sources by directly posting, communicating, or exchanging data with the group.

Furthermore, in an embodiment of the present disclosure, a method and a system for automatically ranking one or more contacts are described. The method includes identifying an activity performed by the owner and associated contacts. A degree of involvement of each contact is computed based on the identified activity performed by the owner and the associated contacts over a time window. Further, the method includes ranking the contact in accordance to the computed degree of involvement. Unlike the system of the related art, the ranks can be used to minimize the need for searching through an alphabetical list of contacts to find a particular favorite contact. For example, if there are a large number of contacts stored on a device or otherwise associated with the device, finding an individual favorite contact based on the name associated with that contact can be difficult and time consuming. The system and method described herein can be used to display the contacts in accordance to their importance to the device user. Listing contacts which are more important towards the top of a list of contacts displayed on the device can typically reduce the search time and enhances the overall user experience.

Throughout the description, the terms pairing and synchronizing (or synching) are used interchangeably.

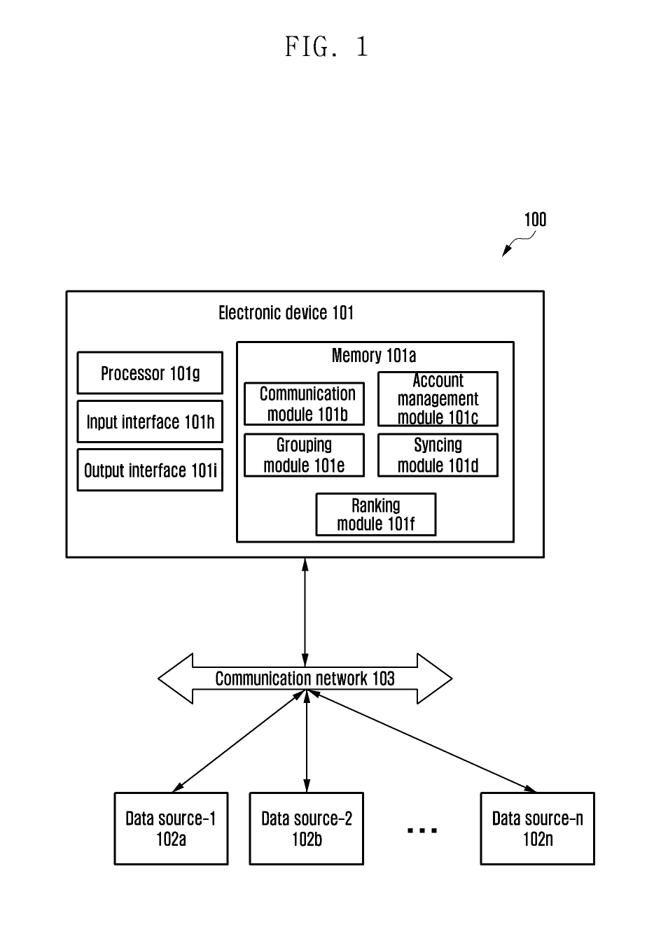

Referring now to the drawings, and more particularly to FIGS. 1 through 23, where similar reference characters denote corresponding features consistently throughout the figures, there are shown various embodiments of the present disclosure.

FIG. 1 illustrates a block diagram of a system for managing contacts obtained from various data sources according to an embodiment of the present disclosure.

Referring to FIG. 1, a system 100 may include an electronic device 101, and one or more data sources 102_{1-N} (hereafter referred as data source(s) 102) communicating among each other over a communication network 103. The communication network 103 described herein can include any suitable combination of wired and/or wireless networks including for example, but not limited to, a Wide Area Network (“WAN”), such as the Internet, a Local Area Network (“LAN”), cell phone networks, Wi-Fi networks, WiMax networks, and the like.

The data source 102 described herein can be any source including contact profile information associated with the user. Examples of data sources can include for example, but not limited to, the electronic device, social network sources, instant messaging sources, voice-over-IP services, and the like. The data source, in some various embodiments, can be a part of the electronic device.

The electronic device 101 can be configured to include a memory 101a, communication module 101b, account management module 101c, syncing module 101d, grouping module 101e, ranking module 101f, a processor 101g, input interface 101h, and output interfaces 101i.

The communication module 101b can be configured to provide various interfaces to communicate with different data sources 102 over the communication network 103. In an embodiment of the present disclosure, the electronic device 101 can communicate with the data sources 102 using a web browser or data source application.

The account management module 101c configured to manage data in the memory 101a associated with contacts profile obtained from form the data sources 102. The account management module 101c can be configured to store account identifiers, user credentials or other information required to access and retrieve contacts profile data from the data sources 102. The account management module 101c can be configured to acquire contacts profile data of several contacts associated with the user, and information regarding social media updates and interaction between the user and several contacts, within different SNSs over the communication network 103.

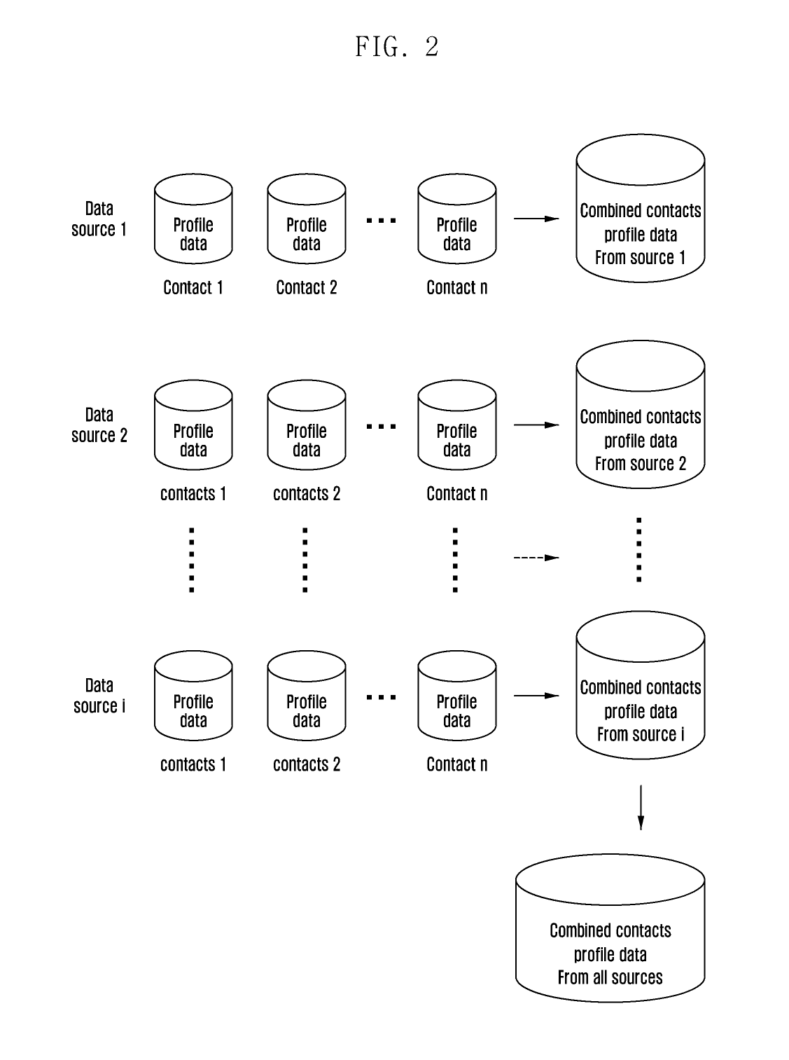

The syncing module 101d can be configured to receive contact profile of the user stored in the memory 101a of the electronic device 101. Each contact profiles a plurality of data items including attributes and sub-attributes. The synching module can be configured to compute a degree of similarity for each contact using a hard match, a soft match or a combination thereof. The degree of similarity between the received contact profile and stored contacts profile can be determined using the data items, such as to synchronize the contacts based on the computed degree of similarity for each contact. Further, details related to the contacts synchronization are explained in conjunction with the FIGS. 2 through 10.

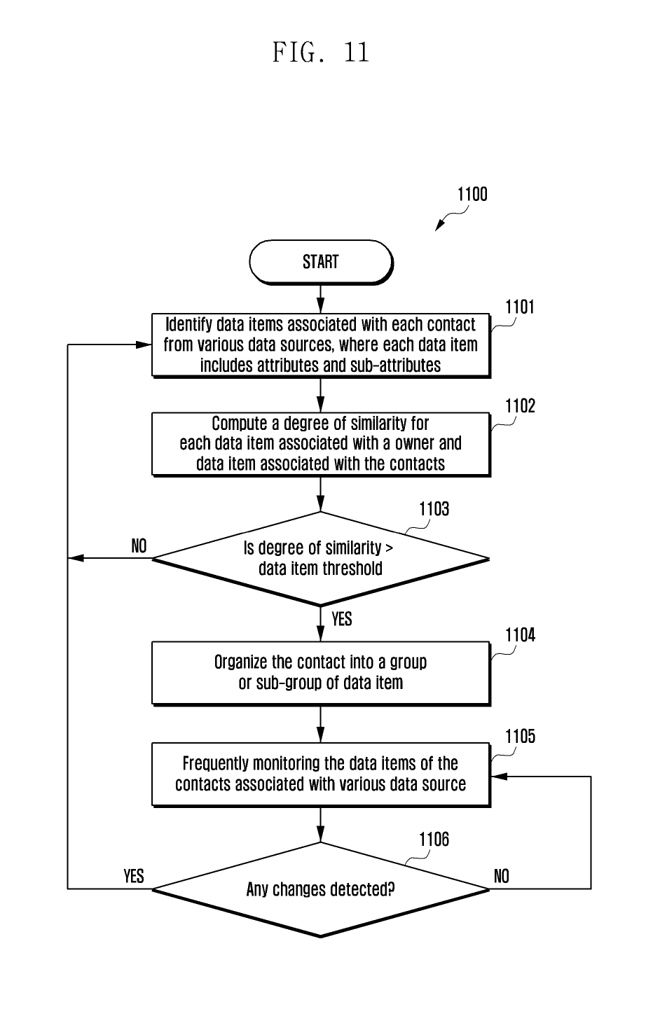

The grouping module 101e can be configured to receive user contact profile stored in the memory 101a of the electronic device 101, and classifies stored contacts profile into one or more groups. The grouping module 101e can be configured to compute a degree of similarity between each data item associated with the owner of the electronic device 101 and data items associated with the contacts, such as to organize the contacts into groups based on the degree of similarity. Further, details related to contacts organization are explained in conjunction with the FIGS. 11 through 13.

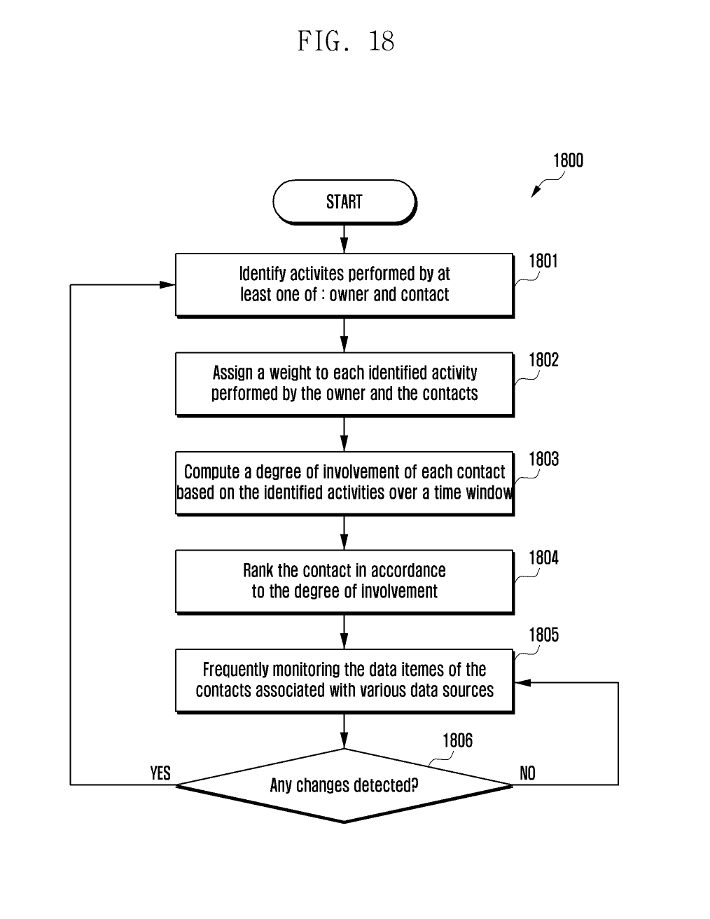

The ranking module 101f can be configured to receive contacts of the user stored in the memory 101a of the electronic device 101 and performs ranking by considering social activities and interactions between device contacts and contacts profile. The ranking module 101f can be configured to compute a degree of involvement based on the activities performed by the user, such as to rank each contact based on the degree of involvement. Further, details related to contacts ranking are explained in conjunction with the FIGS. 18 through 22.

The processor 101g can be configured to generate a notification for the user of the electronic device 101. In an embodiment of the present disclosure, notifications can be generated as recommendations on display of the electronic device 101. Recommendations can also be displayed within other applications for example, within address book of the electronic device 101.

The input interface 101h can be configured to receive an input, such as key presses, and provide input data representative of that input to the processor 101g. The Input interface 101h can provide an interface to for example, but not limited to, a mouse, a keyboard, a micro phone, a touch screen and the like.

The output interfaces 101i can be configured to display information to the user on the electronic device 101. The output interface 101i provides interfaces for example, but not limited to display that includes display circuitry controllable by the processor 101g.

FIG. 1 shows one way of implementation but, it is to be understood that another embodiment is not limited thereto. Further, the system 100 can include any number of modules, electronic devices, data sources along with other hardware or software components communicating with each other over the communication network. For example, the component can be, but not limited to, a process running in the controller or processor, an object, an executable process, a thread of execution, a program, or a computer. By way of illustration, both an application running on an electronic device and the electronic device itself can be a component.

FIG. 2 illustrates an overview of obtaining and combining user contacts profile data from various data sources according to an embodiment of the present disclosure.

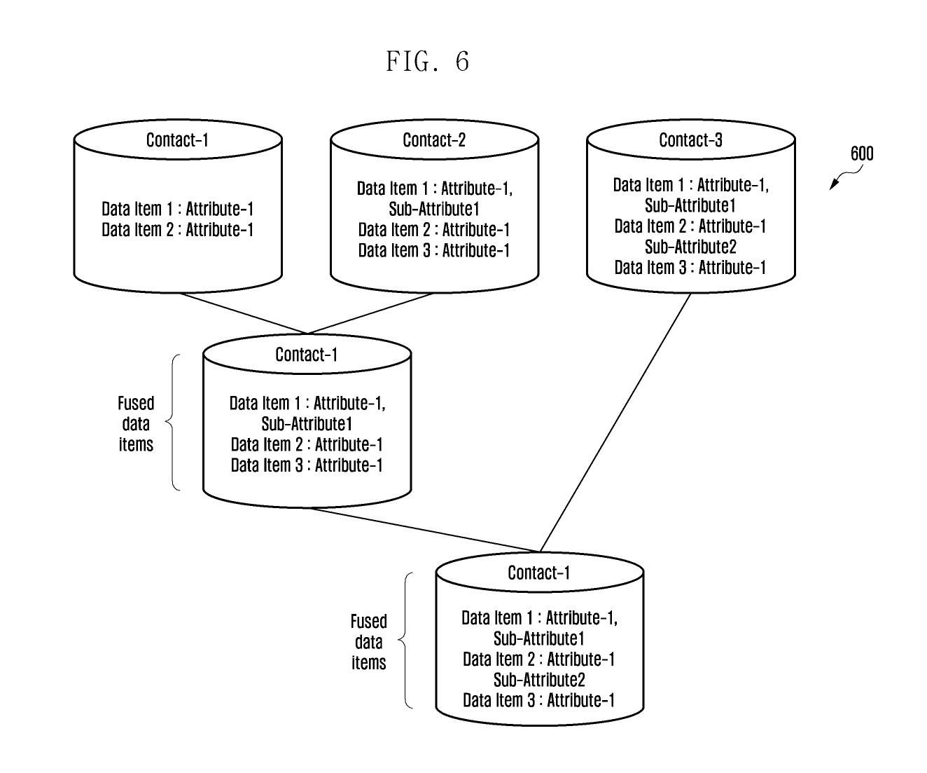

Referring to FIG. 2, the user of the electronic device 101 may initiate syncing, grouping, ranking or in combination by selecting a menu item or other suitable control displayed in the electronic device 101. In response to initiation and provided authentication credentials of the data sources 102, the account management module 101c collects the contacts profile information of a given user ‘u’, existing in different sources, such as source-1, source-2, and the like. For example, combined contacts profile data of the source-1 can be generated by combining the contacts profile, such as contact-1, contact-2, and the like, in the source-1. Similarly, combined contacts profile data from different sources can be generated, and combined profile data of the data sources is combined to generate combined contacts profile data from all sources. Further, details related to the fusion of data associated with same contacts are described in conjunction with the FIG. 6.

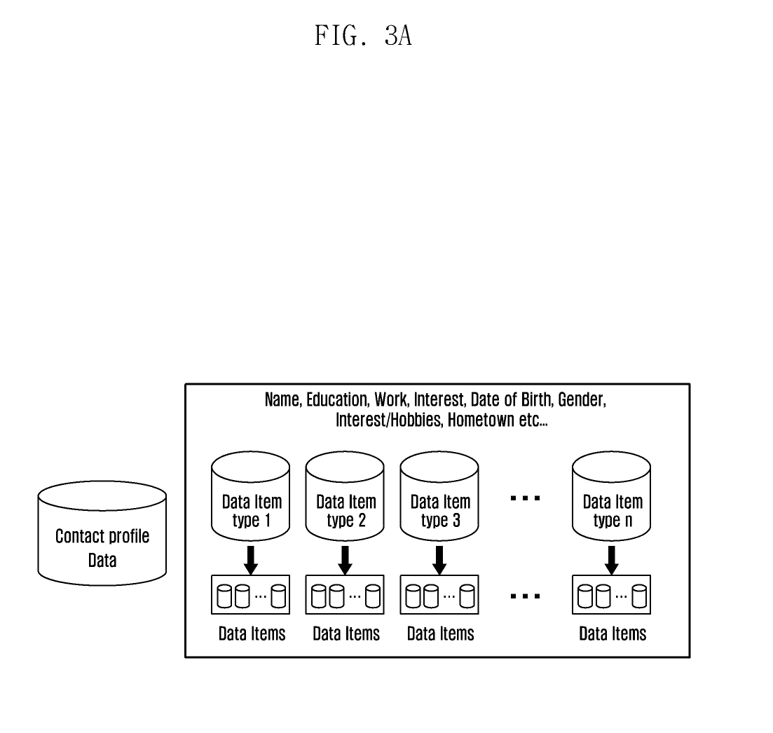

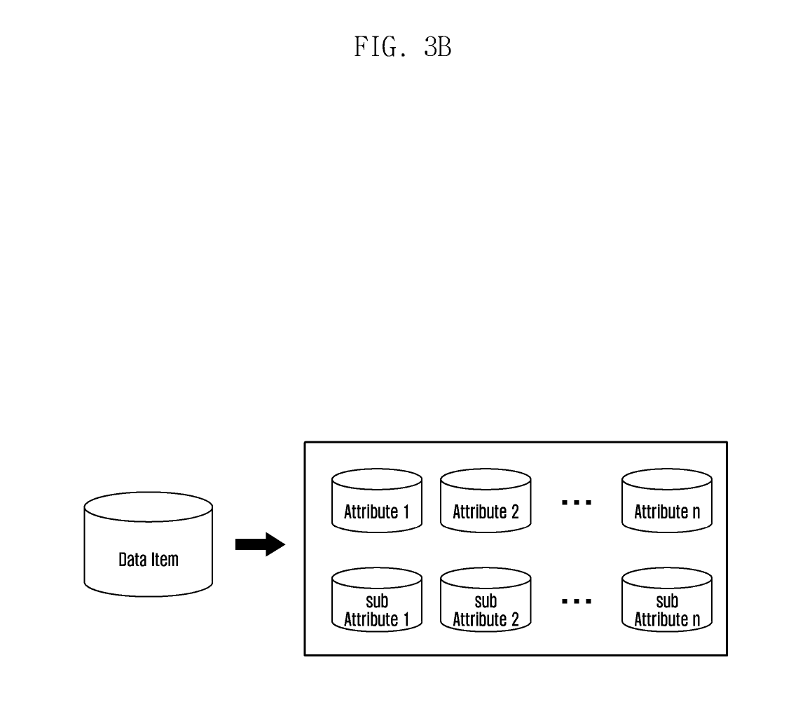

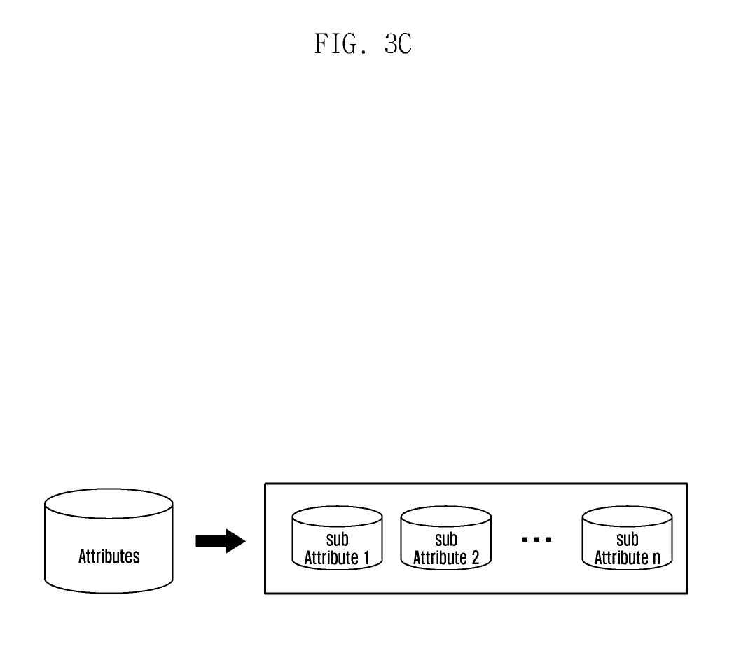

FIG. 3A illustrates a contribution of contact profile according to an embodiment of the present disclosure.

Referring to FIG. 3A, the contact profile described herein includes various data items types, such as data item type-1, data item type-2, data item type-3, and data item type-n. The data item types described herein can be for example, but not limited to, name, education, work, interest, date of birth, gender, interest/hobbies, hometown, and the like. The information associated with each data type can be broken down to various elementary data items. Each data type includes one or more data items concerning a specific property.

FIG. 3B illustrates a contribution of data items according to an embodiment of the present disclosure. FIG. 3C illustrates a contribution of attributes according to an embodiment of the present disclosure.

Referring to FIGS. 3B and 3C, each data item can include an attribute and sub-attribute. As shown in the FIG. 3C, each attribute can further include sub-attributes, such as sub-attribute-1, sub-attribute-2, and the like.

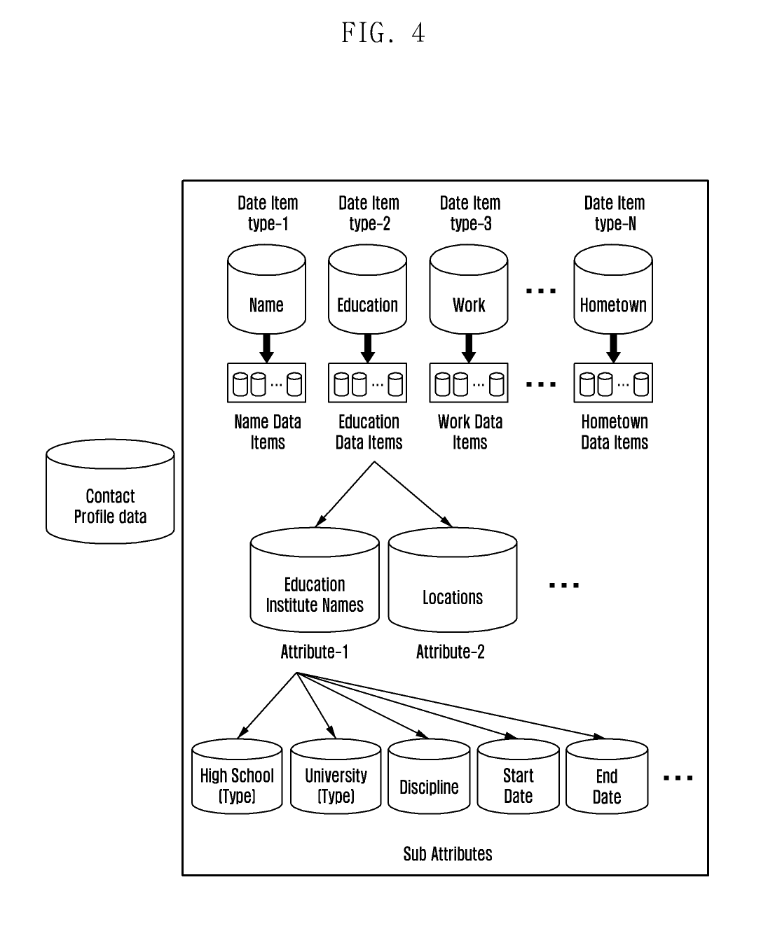

FIG. 4 illustrates contact profile data associated with various data items including attributes and sub-attributes according to an embodiment of the present disclosure.

Referring to FIG. 4, a contact profile can include various data item types, such as name, education, work, hometown, and the like. The information associated with each data type can be associated with various data items concerning a specific property. For example, as shown in the FIG. 4, the data items types can include name data item, education data item, work data item, hometown data item, and the like. Each data item can be associated with attributes and sub-attributes. For example, the education data item can include attributes, such as education institute names, and locations. Further, the education institute names attribute can include sub-attributes, such as high school, university, discipline, start date, end date, and the like. Further, a degree of similarity for each contact can be computed using the identified data items and their respective attributes and sub-attributes.

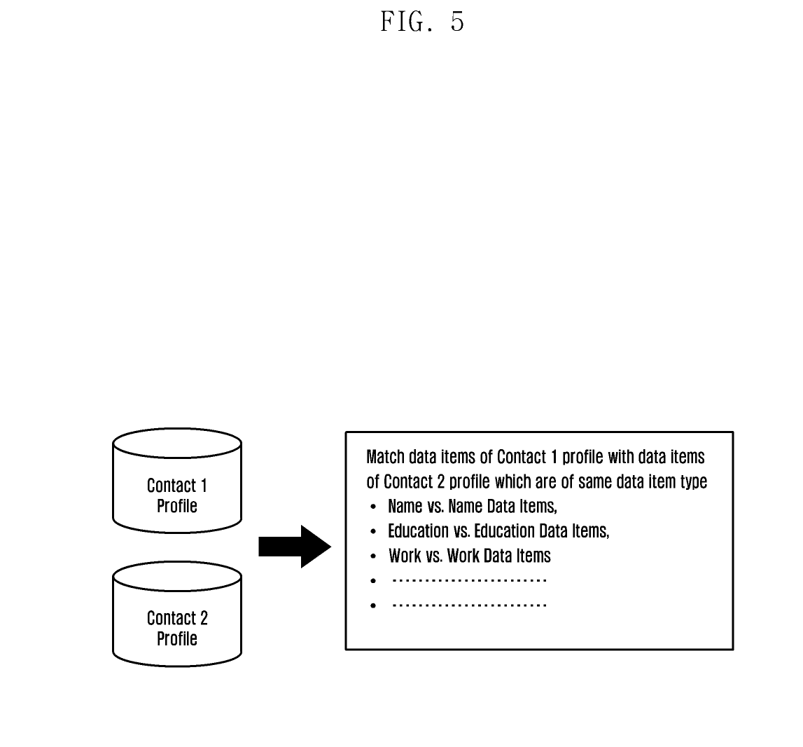

FIG. 5 illustrates data items used for determining a degree of similarity according to an embodiment of the present disclosure.

Referring to FIG. 5, the degree of similarity score can be computed by determining a match between data items of contact-1 profile with data items of the contact-2 profile, which are of same data item types. For example, name data item of the contact-1 profile versus name data item of the contact-2 profile, education data item of the contact-1 profile versus education data item of the contact-2 profile, work data item of the contact-1 profile versus work data item of the contact-2 profile, and the like. Note that similarity of score using same data item types are computed. In other words, no cross data item types of contacts are considered to compute the degree of similarity score.

FIG. 6 illustrates data items fusion according to an embodiment of the present disclosure.

Referring to FIG. 6, consider Contact (C) as C1, C2, and C3. The C1 is associated with Data Items (DIs) DI1 including an attribute-1, and DI2 including an attribute-1. Similarly, the C2 is associated with DI1 including an attribute-1, and sub-attribute-1, DI2 including an attribute-1, and DI3 including an attribute-1. Similarly, the C3 is associated with DU1 including an attribute-1, and sub-attribute-1, DI2 including an attribute-1, and sub-attribute-2, and DI3 including an attribute-1. The synching module is configured to identify the data items associated with the C1 and C2. The degree of similarity between the C1 and C2 is computed and can be automatically synched or provided as recommendation to synch the C1 and C2. Once the contacts C1 and C2 is synched, the synching module can be configured to fuse the data items associated with the C1 and the C2. As shown in the FIG. 6, the data items of attributes and sub-attributes can be fused together to effectively compute the degree of similarity of each contact and synch the contacts in response to determining that the computed degree of similarity exceeds a contact threshold. Similarly, once the data items are fused together, the synching module can be configured to compute the degree of similarity between the C1 and C3 using the fused data items of C1 and data items of the C3. Once the contacts C1 and C3 is synched based on the degree of similarity, the synching module can be configured to fuse the data items associated with the C1 and the C3.

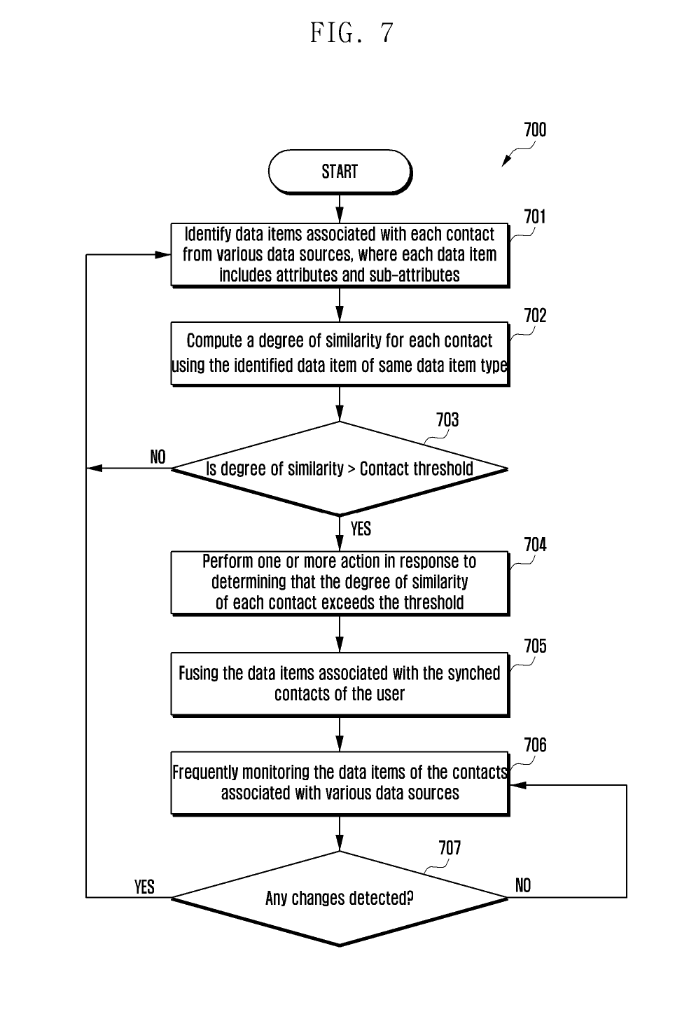

FIG. 7 is a flow diagram illustrating a method for synchronizing contacts associated with various sources according to an embodiment of the present disclosure.

Referring to FIG. 7, at operation 701, the method 700 includes identifying the data item(s) associated with each contact from various data sources 102. The electronic device 101 can be configured to include contacts of various users, such as family, friends, colleagues, and the like. Some of the contact of the electronic device 101 can be direct contacts of the electronic device 101 and some of which is obtained from other data sources, such as Facebook, Foursquare, Linked-in and the like. The method 700 allows the electronic device 101 to identify the data items associated each contact. Each data item includes an attribute, a sub-attribute, and the like indicating various fields of the contact profiles.

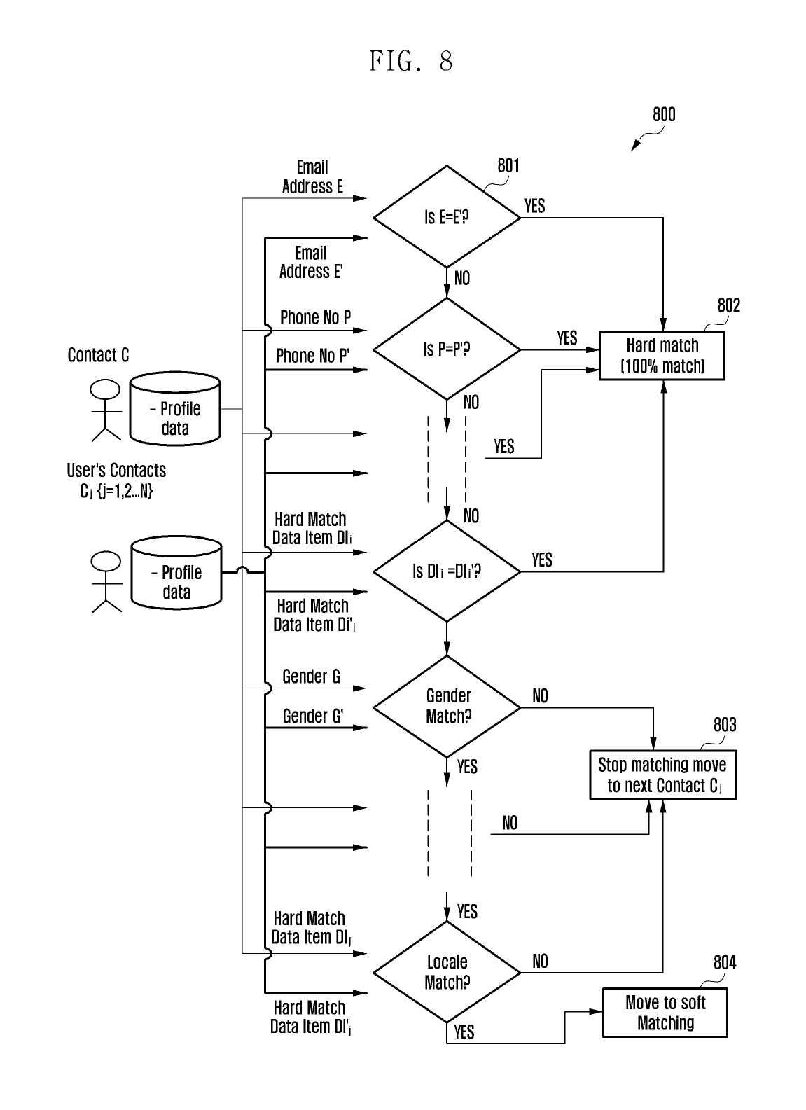

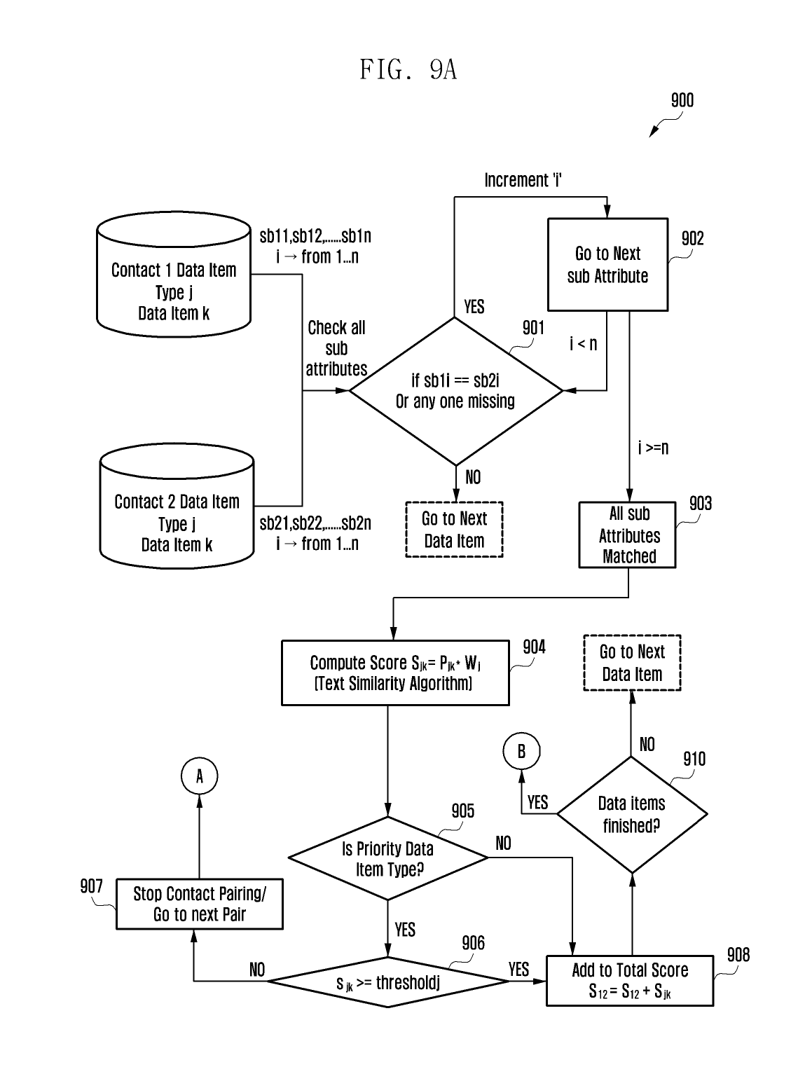

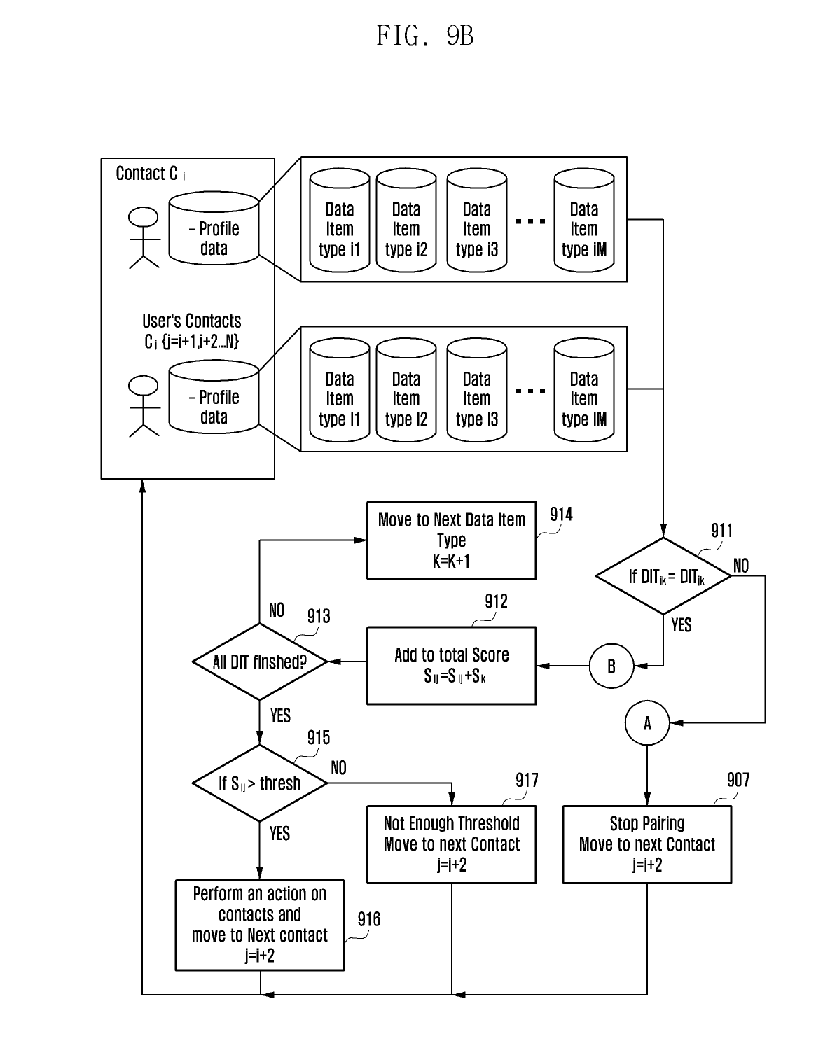

At operation 702, the method 700 includes computing a degree of similarity for each contact using the identified data item of same data item type. The method 700 allows the synching module to compute a degree of similarity by comparing data fields of each contact with the data fields of other contacts. In an embodiment of the present disclosure, the method 700 allows the synching module to compute a degree of similarity for each contact using a hard match, a soft match or a combination thereof. The degree of similarity between a selected contact profile and other stored contacts profile can be determined using the data items, such as to synchronize the contacts based on the computed degree of similarity for each contact. Unlike system of the related art, the unique profile attributes and additional sub-attributes can be used to compute the degree of similarity, such as to enhance the accuracy of synchronization. For example, if a contact has employer organization as “Samsung” as a profile attribute, then the system and method also uses additional sub-attributes, such as employment start date, end dates, position in organization, working domain/area, and the like, such as to accurately identify and synchronize the same contacts. Further, details related to computation of the degree of similarity are explained in conjunction with the FIGS. 8 and 9.

At operation 703, the method 700 includes determining whether the degree of similarity associated with each contact exceeds a contact threshold. The contact threshold described herein defines a numeric value used to identify whether a contact qualifies to be synched with other contact. The method 700 allows the synching module to compare the degree of similarity of each contact with the contact threshold.

At operation 704, the method 700 includes performing one or more action in response to determining that the degree of similarity of each contact exceeds the contact threshold. The actions described herein can be for example, but not limited to, providing recommendations to sync the contacts of the user, automatically synching the contacts of the user, and the like. The method 700 allows the synching module to either automatically synchronize the contacts or provide recommendations to the user to sync the contacts in response to determining that the degree of similarity of each contact exceeds the contact threshold.

At operation 705, the method 700 includes fusing the data items associated with the synched contacts of the user. The data items associated with each contact and synched contact is stored in the electronic device 101. The method 700 allows the synching module to automatically fuse the data items of the synched contacts, such as to effectively manage the contacts. An example illustration of data fusion is described in conjunction with the FIG. 6.

At operation 706, the method 700 includes frequently monitoring the data items of the contacts associated with various data sources 102. The method 700 allows the synching module to periodically monitor the changes performed by the user on the data items of the contact profile. For example, the synching module may periodically monitor whether any of the data item is added or subtracted or modified over a time window by the user. At operation 707, the method 700 includes repeating the operations 701 to 707 in response to determining any changes performed on the data items of the contacts.

FIG. 8 is a flow diagram illustrating a method for pairing contact profiles obtained from various data sources by performing hard match between contacts profile according to an embodiment of the present disclosure.

Referring to FIG. 8, in the hard match, one or more uniquely identified data items of each contact profile is compared with each other contact profile obtained from various data sources 102. As described in the FIG. 4, the contacts profiles associated with the user within one or more sources are combined to generate the fused contacts profile data. In an example, the contact profile received by the electronic device 101 is considered as a selected contact profile and compared with each contact profile from the fused contacts profile data to identify the matching contact profiles for the selected contact profile.

The methods disclosed herein perform pairing of contacts profile by performing both the hard match between contacts profile, and the soft match between contacts profile. If one or more matching contact profiles for the selected contact profile are not identified during the hard match, then the method 800 performs the soft match between the selected contact profile and contacts profile from the fused contacts profile data, such as described in the FIG. 7.

In the hard match, the method 800 compares the uniquely identified data items of the selected contact profile with uniquely identified data fields of the contacts profile from the fused contacts profile data. Whereas in the soft match, the method 800 compares the data items other than the uniquely identified data items of the selected contact profile with the data items other than the uniquely identified data items of the contacts profile from the fused contacts profile data. By way of an example and not limitation, one or more uniquely identified data items are considered as Phone number (P), Email ID (E), Instant Messengers ID (IM), and the like. However, it is to be understood that other data items are not limited thereto.

At operation 801, the method 800 includes comparing data in one or more uniquely identified data items of the contacts profile (C₁, C₂, C₃ . . . Cₙ) with one or more uniquely identified data items of the selected contact profile (C). In an embodiment of the present disclosure, existing string matching technique can be used to compare the data in the uniquely identified data items while performing the hard match as shown at operation 802. For example, the phone number P of the selected contact profile is compared with the phone number P¹ of the contact profile C₁ while performing the hard match.

Further, the method 800 includes automatically synching the selected contact profile (C) and the contacts profile from the fused contacts profile data to the user of the electronic device 101, if data of the uniquely identified data items of the selected contact profile (C) is the same as data in the corresponding uniquely identified data items of the contacts profile (C₁, C₂, C₃ . . . Cₙ) from the fused contacts profile data. For example, one or more uniquely identified data items of a first contact profile (C₁) from the fused profile data is the same as one or more uniquely identified data items of the selected contact profile (C), then the method 800 allows the synching module to automatically synch the selected contact profile (C) and the first contact profile (C₁).

For example, if the first contact profile (C₁) includes three data items, then the method 800 includes comparing data in first data item of the first contact profile (C₁) with data in corresponding data item of the selected contact profile (C). Further, the method 800 includes comparing data in next data items of the first contact profile (C₁) with data in the corresponding data items of the selected contact profile (C) in response to determining that the data in the first data item of the first contact profile (C₁) is the same or similar to the data in the corresponding data item of the selected contact profile (C). Similarly, the method 800 includes comparing the successive data items based on the comparison result of the previous data items.

Similarly, the method 800 repeats the operations to perform the hard match between other contacts profiles (C₂, C₃ . . . Cₙ) from the fused contacts profile data and the selected contact profile. Further, the method 800 includes recommending the user for pairing the contacts based on the comparison result. If the data in the uniquely identified data items of the selected contact profile (C) is different from data in corresponding uniquely identified data items of the contacts profile from the fused profile data (for example, the first contact profile (C₁) from the fused profile data) then the method 800 includes performing the hard match between a second contact profile (C₂) from the fused profile data and the selected contact profile (C) by repeating the operation 802.

Further, the method 800 includes determining whether the gender of the selected contact profile (C) and the gender of the first contact profile (C₁) are the same. At operation 803, in response to determining that the gender of the selected contact profile (C) and the gender of the first contact profile (C₁) are not the same, the method 800 including stopping the match of the current contacts data items and move to the next contact. In an embodiment of the present disclosure, in response to determining that the gender of the selected contact profile (C) and the gender of the first contact profile (C₁) are the same, the method 800 includes determining a local match between the selected contact profile (C) and the first contact profile (C₁). At operation 804, the method 800 includes performing the soft match between the first contact profile (C₁) and the selected contact profile (C).

Similarly, the method of soft match is performed between one or more other contacts profile (C₂, C₃ . . . Cₙ) and the selected contact profile (C), if the data in uniquely identified data items of the selected contact profile (C) is different from the data in the uniquely identified data items of the other contact profiles (C₂, C₃ . . . Cₙ).

FIGS. 9A and 9B are flow diagrams illustrating a method for pairing or syncing one or more user contacts profile obtained from one or more sources using soft match between contacts profile according to an embodiment of the present disclosure.

In an embodiment of the present disclosure, at operation 804 of flow diagram 800, if the uniquely identified data items of the contacts profile (C₁, C₂, C₃ . . . Cₙ) from the fused contacts profile data is different from the uniquely identified data items of the selected contact profile (C), but if the gender and location of the contacts profile (C₁, C₂, C₃ . . . Cₙ) and the gender and location of the selected contact profile are the same, then the method performs the soft match to compute a degree of similarity for each contact using a static decision tree and a probabilistic method. By way of an example and not limitation, the probabilistic method comprises one of a text similarity method.

Referring to FIGS. 9A and 9B, the contact profile described herein includes various data items types, such as data item type-1, data item type-2, data item type-3, and data item type-n. The information associated with each data type can be broken down to various elementary data items inducing attributes and sub-attributes. At operation 901, the method 900 includes determining whether attributes or sub-attributes (sb1i) of first data item associated with first data item type of a contact-1 is equal to the attributes or sub-attributes (sb2i) of first data item associated with first data item type of a contact-2. In response to determining that the attributes or sub-attributes (sb1i) of the first data item associated with the first data item type of the contact-1 is not equal to the attributes or sub-attributes (sb2i) of the first data item associated with the first data item type of the contact-2, the method 900 includes selecting the next data item in the first data item type. At operation 902, the method 900 includes selecting next attribute or sub-attribute of the first data item. For example, each data item can include various attributes and sub-attribute. In response to determining that the first sub-attribute of the first data item associated with first data item type of the contact-1 matches with the attributes or sub-attributes of the first data item associated with the first data item type of the contact-2, the method 900 allows the syncing module 101d to select the next attribute or sub-attribute of the first data item.

At operation 903, the method 900 allows the syncing module 101d to determine whether all the attributes or sub-attributes of the first data item associated with the first data item type of the contact-1 is matched with all the attributes or sub-attributes of the first data item associated with the first data item type of the contact-2.

At operation 904, the method 900 includes computing a similarity (or weightage) score for each data item of the contact-1 and the contact-2. The similarity score generated between the data item of the contact-1 and the corresponding data item of the contact-2 is indicative of a Probability (P) that data in the data item of the contact-1 is relevant to data in corresponding data item of the contact-2. Each attribute of the one or more data items of the contact-1 is compared with the attribute of corresponding one data item of the contact-2 before generating the probability. If any one of the attribute of the data item of the contact-1 is different from the corresponding attributes of corresponding data item of the contact-2 then the method 900 selects the next data item.

Further, the method 900 includes multiplying the matching probability with a static or dynamic weight associated with the data item to compute the similarity score of the data item. Each data item can be associated with a weight which can be dynamically changed based on the availability of the attributes and sub-attributes in the contacts. The similarity score of each data item is a combination of assigned weight and determined probability score for that particular data item.

At operation 905, the method 900 includes determining whether the data item type is a priority data item type. In response to determining that the data item type is priority data type, the method 900 includes determining whether the similarity score of the data item exceeds a data item threshold, such as shown at operation 906. At operation 907, the method 900 includes terminating the pairing or syncing of contact and selecting the next contact in response to determining that the similarity score of the data item is within the data item threshold. At operation 908, the method 900 includes appending the similarity score of the data item to the total score of the data item type. In response to determining that the similarity score of the data item exceeds the data item threshold, the method 900 allows the synching module 101d to add the similarity score of the data item to the total similarity score of the contact.

At operation 910, the method 900 includes determining whether all the data items associated with the first data item type are finished. At operation 911, the method 900 includes determining whether the next data item type of the contact-1 is the same as the next data item type of the contact-2. In response to determining that the data item associated with first data item type is finished, the method 900 allows the synching module 101d to determine whether the next data item type of the contact-1 is the same as the next data item type of the contact-2.

Further, a similarity score is computed for data items associated with each data item type contact by repeating the operations 901 through 911. At operation 912, the method 900 includes computing the total degree of similarity score by appending each similarity score associated with the data item types. The total degree of similarity score between the contact-1 and the contact-2 is computed using Equation (1) provided below.

S₁=W₁P₁+W₂P₂₊W₃P₃+ . . . +WᵢPᵢ Equation (1)

where, ‘i’ is number of data fields of the contact profile, W₁P₁ is the weightage of first data item, W₂P₂ is the weightage score of the second data item and the like.

Similarly, the degree of similarity between the second contact profile (C2) and the selected contact profile (C) is denoted as S₂. Similarly, the degree of similarity between the third contact profile (C₂) and the selected contact profile (C) is denoted as S₃. Similarly, the degree of similarity between the n^{th} contact profile (Cₙ) and the selected contact profile is denoted as Sₙ.

At operation 913, the method 900 includes determining whether all the data item types associated with the contact are finished. At operation 914, in response to determining that all the data items are not finished, the method 400 includes selecting the next data item type and repeating the operations 901 to 914. At operation 915, the method 900 includes determining whether the degree of similarity of each contact exceeds a contact threshold. At operation 916, the method 900 includes performing one or more actions in response to determining that the degree of similarity of each contact exceeds the contact threshold. The actions described herein can be for example, but not limited to, providing recommendations to sync the contacts of the user, automatically synching the contacts of the user, and the like. The method 900 allows the synching module to either automatically synchronize the contacts or provide recommendations to the user to sync the contacts in response to determining that the degree of similarity of each contact exceeds the contact threshold. At operation 917, the method 900 includes selecting next contact and repeating the operations 901 to 917.

Furthermore, in an embodiment of the present disclosure, the method 900 updates the fused contact profile data and repeats the method operations described in flow diagram 800 and/or 900. For example, if first contact profile C₁ and selected contact profile C are paired based on the recommendation, then the contact profiles C₁ and C are treated as a single contact profile (C₁, C) and accordingly the fused contacts profile data is updated. A matching probability for each data item of each contact with each other data item of each other contact is determined. The data items other than uniquely identified data fields of the first contact profile (C₁) is compared with corresponding one or more data items other than the uniquely identified data items of the selected contact profile (C), such as to compute the degree of similarity for each contact using the data items. In an example, the method 900 is described using soft matching between a first contact profile (C₁) from the fused contact profile data and the selected contact profile (C) to compute the degree of similarity for each contact. However the method of soft match between other contacts profile (C₂, C₃ . . . Cₙ) and the selected contact performed in similar manner to compute the degree of similarity between the selected contact profile (C) and one or more other contacts profile (C₂, C₃ . . . Cₙ) from the fused contacts profile data.

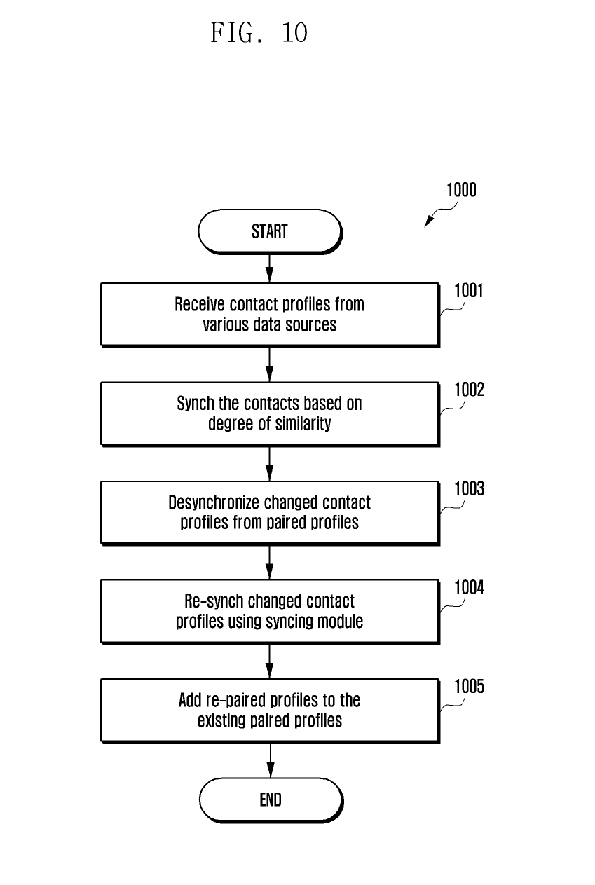

FIG. 10 is a flow diagram illustrating a method for re-synchronizing contact profile according to an embodiment of the present disclosure.

Referring to FIG. 10, at operation 1001, the method 1000 includes receiving contact profiles from various data sources 102. Each contact is associated with data items including attributes and sub-attributes. At operation 1002, the method 1000 includes synching the contacts based on the degree of similarity. The degree of similarity for each contact can be computed using the identified data items and compared against a contact threshold. The method 1000 allows the synching module to synchronize the contacts in response to determining that the degree of similarity exceeds a threshold.

At operation 1003, the method 1000 includes desynchronizing the changed or modified contact profiles. If one or more contacts profile from the synchronized contacts profiles list are modified, then the method 1000 allows the synching module to delete the corresponding modified contacts profile from the synchronized contacts profile list and fused contacts profile data. At operation 1004, the method 1000 includes repairing/re-synchronizing the changed contact profiles using the syncing module 101d. The method 1000 allows the synching module to identify the modified data items associated with the contact profile and repair the modified contacts with the updated value. At operation 1005, the method 1000 includes adding repaired contact to the existing paired contacts. The identified one or more contact profiles to pair with one or more modified contacts profile are recommended to the user and added to existing paired contacts profile list.

FIG. 11 is a flow diagram illustrating a method for organizing contact profiles into one or more groups according to an embodiment of the present disclosure.

Referring to FIG. 11, at operation 1101, the method 1100 includes identifying the data item(s) associated with each contact from various data sources 102. The electronic device 101 can be configured to include contacts of various users such as family, friends, colleagues, and the like. Some of the contact of the electronic device 101 can be direct contacts of the electronic device 101 and some of which is obtained from other data sources, such as Facebook, Foursquare, Linked-in and the like. The method 1100 allows the electronic device 101 to identify the data items associated each contact. Each data item includes an attribute, a sub-attribute, and the like indicating various fields of the contact profiles.

At operation 1102, the method 1100 includes computing a degree of similarity for each data item associated with the owner of the electronic device 101 and data item associated with the contacts. The method 1100 allows the grouping module 101e to compute the degree of similarity by comparing data fields of each contact with the data fields of owner.

At operation 1103, the method 1100 includes determining whether the degree of similarity associated with each data item exceeds a data item threshold. The data item threshold described herein defines a numeric value used to identify whether a contact qualifies to be categorized into a group including the data item. The method 1100 allows the grouping module 101e to compare the degree of similarity of each data item with the data item threshold.

At operation 1104, the method 1100 includes organizing the contact into a group or sub-group of the data item in response to determining that the degree of similarity of each data item exceeds the data item threshold. At operation 1105, the method 1100 includes frequently monitoring the data items of the contacts associated with various data sources 102. The method 1100 allows the grouping module 101e to periodically monitor the changes performed by the user on the data items of the contact profile. For example, the grouping module 101e may periodically monitor whether any of the data item is added or subtracted or modified over a period of time by the user. At operation 1106, the method 1100 includes repeating the operations 1101 to 1106 in response to determining any changes performed on the data items of the contacts.

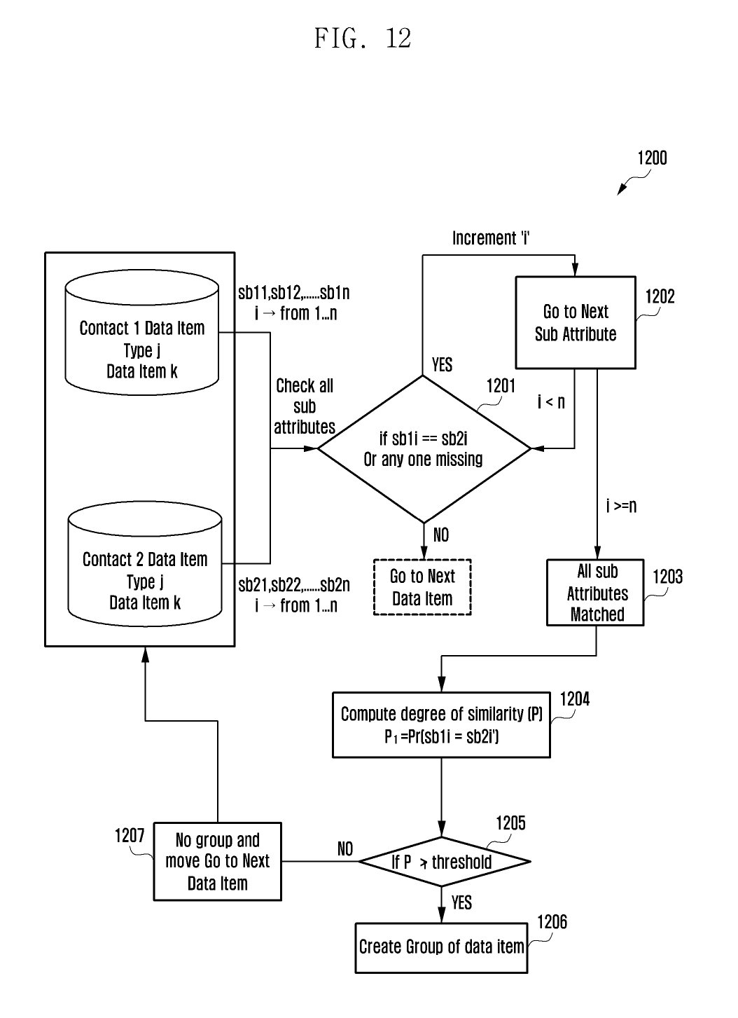

FIG. 12 is a flow diagram illustrating a method for grouping one or more user using data items including attributes and sub-attributes contacts profile according to an embodiment of the present disclosure.

Referring to FIG. 12, the contact profile can include various data items types, such as data item type-1, data item type-2, data item type-3, and data item type-n. The information associated with each data type can be broken down to various elementary data items inducing attributes and sub-attributes. At operation 1201, the method 1200 includes determining whether attributes or sub-attributes (sb1i) of first data item associated with first data item type of an owner is equal to the attributes or sub-attributes (sb2i) of first data item associated with first data item type of a contact. In response to determining that the attributes or sub-attributes (sb1i) of the first data item associated with the first data item type of the owner is not equal to the attributes or sub-attributes (sb2i) of the first data item associated with the first data item type of the contact, the method 1200 includes selecting the next data item in the first data item type. At operation 1202, the method 1200 includes selecting next attribute or sub-attribute of the first data item. For example, each data item can include various attributes and sub-attribute. In response to determining that the first sub-attribute of the first data item associated with first data item type of the owner matches with the attributes or sub-attributes of the first data item associated with the first data item type of the contact, the method 1200 allows the grouping module 101e to select the next attribute or sub-attribute of the first data item.

At operation 1203, the method 1200 allows the grouping module 101e to determine whether all the attributes or sub-attributes of the first data item associated with the first data item type of the owner is matched with all the attributes or sub-attributes of the first data item associated with the first data item type of the contact.

At operation 1204, the method 900 includes computing a degree of similarity between the data item associated with the owner with the data item associated with the contact. The similarity score generated between the data item of the owner and the corresponding data item of the contact is indicative of a Probability (P) that data in the data item of the owner is relevant to data in corresponding data item of the contact. Each attribute of the one or more data items of the owner is compared with the attribute of corresponding one data item of the contact before generating the probability. If any one of the attribute of the data item of the owner is different from the corresponding attributes of corresponding data item of the contact then the method 1200 selects the next data item.

At operation 1205, the method 1200 includes determining whether the degree of similarity associated with each data item exceeds a data item threshold. The data item threshold described herein defines a numeric value used to identify whether a contact qualifies to be categorized into a group including the data item. The method 1200 allows the grouping module 101e to compare the degree of similarity of each data item with the data item threshold. At operation 1206, the method 1200 includes organizing the contact into a group or sub-group of the data item in response to determining that the degree of similarity of each data item exceeds the data item threshold. Further at operation 1207, in response to determining that the degree of similarity of each data item does not exceed the data item threshold, the method 1200 includes selecting next data item associated with the owner and repeating the operations 1201 to 1207.

FIG. 13 is a flow diagram illustrating a method for organizing contact profiles into one or more groups according to an embodiment of the present disclosure.

Referring to FIG. 13, the contacts can be automatically classified by classifying the one or more contacts profile from the fused contact profile data obtained from different sources into one or more groups. Each contact profile may be categorized into a group or subgroup using the data items associated with each contact. For example, the contacts can be classified into a group including family, colleagues, classmates, and the like.

Each data item of the user or owner of the electronic device 101 can be compared against each data item associated with the contact profiles from fused contact profile data, such as to compute the degree of similarity. Each attribute of one or more data item of the owner is compared with corresponding attribute of corresponding data items of each contact profile from the fused contact profile data. Various embodiments disclosed herein is explained by considering data fields, such as hobbies (I), work information (W), education information (Ed) and home town (H). However, it is to be understood that any other data item including attributes and sub-attributed are not limited thereto.

In an embodiment of the present disclosure, at operation 1301, the method 1300 includes determining a degree of similarity (P) between a data item associated with the owner of the electronic device with the data items associated with the contacts. The attributes associated with the data items of the owner from the fused contact profile is compared with corresponding the attributes of the contact profile. For example, the attributes of work information (W) of the owner is compared with the corresponding attributes of work information (W′) of the user contact profile (U). If the attributes of the work information (W) of the owner is same as corresponding to the attributes of the work information (W′) of the user contact profile (U) then the degree of similarity is computed between the work information (W′) and the work information (W). For example, if the attributes of the work information (W) of the owner is different from corresponding the attributes of the work information (W′) of the user contact profile (U) then no group is created for the work information data item.

Similarly, the degree of similarity is computed for all the data fields of the owner. For example, as shown in the FIG. 13, the degree of similarity computed for hobbies is represented as P1, degree of similarity computed for education information is represented as P3, and the degree of similarity computed for hobbies is represented as P4.

At operation 1302, the method 1300 includes determining whether the degree of similarity associated with each data item exceed the data item threshold. If computed degree of similarity of the data item exceeds the data item threshold corresponding to that data item then the contacts including that data item can be organized into a group or sub-group of that data item.

As shown in the FIG. 13, if the computed degree of similarity for the work information, education information and home town data items exceeds the data item threshold associated with corresponding data items then the first contact profile (C1) is assigned to three groups, such as a work group, an education group, and a home town group. Further, if the computed degree of similarity of one or more data items of the first contact profile (C1) is less than data item threshold corresponding to that data item then no group is created for that data item of the first contact profile (C1). Similarly, the grouping of contacts can be performed for each data item of the owner of the electronic device 101.

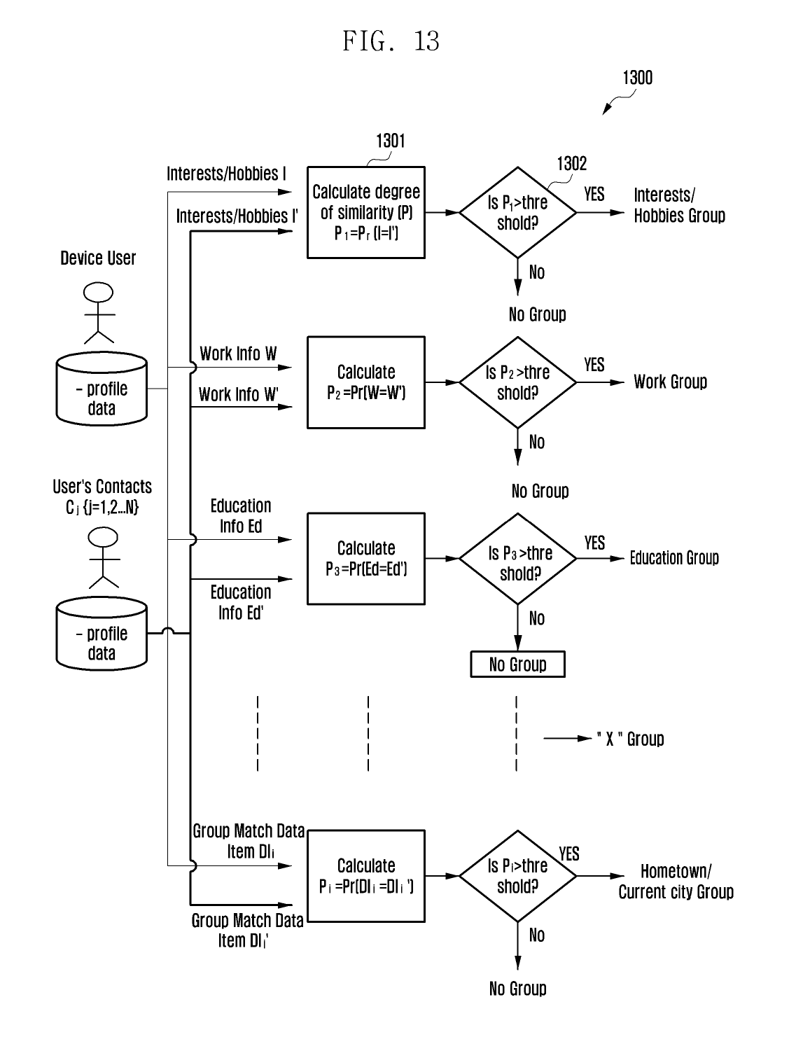

FIG. 14 is a flow diagram illustrating a method for re-grouping updated at least one contact profile according to an embodiment of the present disclosure.

Referring to FIG. 14, at operation 1401, the method 1400 includes receiving contact profiles from various data sources 102. Each contact is associated with data items including attributes and sub-attributes. At operation 1402, the method 1400 includes grouping contact into a group or sub-group based on the data items. A degree of similarity can be computed between the identified data item associated with the user (or owner) and other data items associated with the contact. The contacts can be organized into a group (or sub-group) of data item in response to determining that the degree of similarity for each data item exceeds the threshold.

At operation 1403, the method 1400 includes ungrouping changed or modified contacts based on data items. If the data items associated with the contacts from the list of the created groups are modified then the method 1400 allows the grouping module 101e to delete the corresponding modified contacts profile from the one or more groups and fused contacts profile data. At operation 1404, the method 1400 includes regrouping the changed contact profile using the grouping module 101e. At operation 1405, the method 1400 includes adding changed or modified contacts into existing or new groups of data item. If any of the data item is modified then the method 1400 allows the grouping module 101e to re-compute the degree of similarity between the data item of the owner with the data item of the modified contacts. Further, the method 1400 allows the grouping module 101e to add the modified contacts into a new group or existing group of the data item in response to determining that the degree of similarity of the modified data item exceeds corresponding data item threshold.

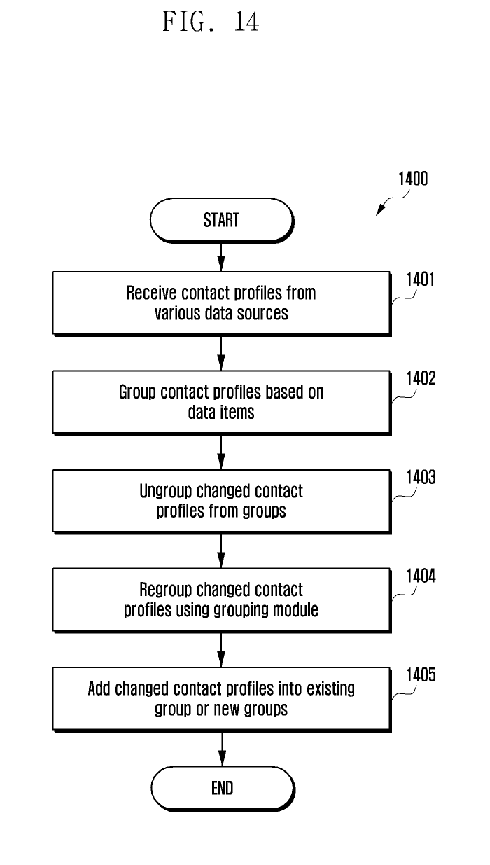

FIG. 15 is a flow diagram illustrating a method for text tokenization according to an embodiment of the present disclosure.

The degree of similarity for each contact is computed using the data items. Text tokenization method as described herein can used to generate one or more tokenized strings associated with the attributes or sub-attributes of the data items and which is provided as an input to the text similarity method, such as to compute the degree of similarity for each contact. A weightage for each data item is computed by determining the matching probability between the data items and multiplying with a static or dynamic weight, such as to compute the degree of similarity for each contact.

Referring to FIG. 15, at operation 1501, the method 1500 includes receiving the string S₁ for tokenization. The string S1 corresponds to data in data item of a contact profile. Each string can include different symbols, words, and the like. At operation 1502, the method 1500 includes replacing the symbols with spaces in the string. The symbols in the string, such as {‘.’, ‘,’, ‘/’,} in the string S₁, are identified and replaced with white spaces. At operation 1503, the method 1500 includes generating a modified string. For example, if the inputs string S₁ is “Mr. Rajesh Kumar” then the tokenization method replaces ‘.’ with white space and generates modified string as “Mr. Rajesh Kumar”. At operation 1504, the modified 1500 includes splitting the string into words. The string S₁′ can be divided into words based on the space. In the above example, the modified string “Mr. Rajesh Kumar” can be divided by space into three words, such as W₁, W2, and W₃, respectively (where W₁ represents “Mr”, W₂ represents “Rajesh” and W₃ represents “Kumar”).

At operation 1505, the method 1500 includes removing the stop words from the sting. The words of the string are compared with stop words list. The stop words described herein can include for example, but are not limited to, Pvt., Ltd, Mr., Mrs., PhD, and the like. If a word is a stop word, then corresponding word is removed from the generated words. In the above example, the word “Mr” is removed from the words of modified string S₁′. At operation 1506, the method 1500 includes generating tokenized string S₁ with words {W₁′, W₂′, W₃′ . . . Wn¹). In the above example, the words of the tokenized string of “Mr. Rajesh Kumar” can be {W₁: Rajesh, W₂: Kumar}.

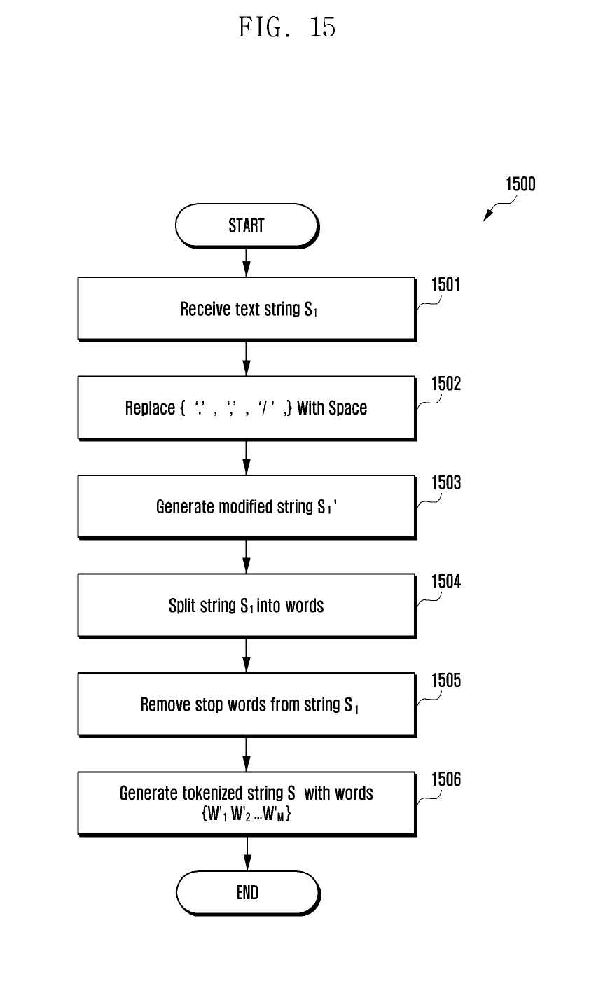

FIG. 16 is a flow diagram illustrating a text similarity method according to an embodiment of the present disclosure.

In an embodiment of the present disclosure, data in the data items other than uniquely identified data items of the selected contact profile can be compared with data in corresponding one or more data items of the contacts profile from the fused profile data to generate the degree of similarity for each contact using the text similarity method. The inputs to the text similarity method are tokenized strings. For example, tokenized string S₁ corresponds to data in one data field of the selected contact profile and tokenized string S₂ corresponds to data in corresponding data item of a contact profile from the fused contacts profile data.

Referring to FIG. 16, at operation 1601, the method 1600 includes receives tokenized string S₁ with words {W′1, W′₂ . . . W′_{M}} and tokenized string S₂ with words {W₁, W₂ . . . W_{N}}. The tokenized string S₁ and the tokenized string S₂ are obtained upon performing text tokenization of the string S₁ and the string S₂ using the method 1600 disclosed in the flow diagram 1600. At operation 1602, the method 1600 includes selecting each word Wᵢ (i=number of words in the tokenized string S₁) from tokenized String S1 and each word Wⱼ (j=number of words in the tokenized string S₂) from the tokenized String S2. At operation 1603, the method 1600 includes determining a match between the words Wi from the tokenized String S1 and the words Wj from the tokenized String S2. The comparison between the words is performed to identify a relevant match between word Wᵢ and word Wⱼ.

At operation 1604, the method 1600 includes computing a distance between the words Wᵢ from the tokenized String S1 and the words Wⱼ from the tokenized String S2. In response to determining that the word Wᵢ and the word Wⱼ are not matched, the method 1600 computes distance between the word Wᵢ and the word Wⱼ. For example, if the word Wᵢ is “XYZ123” and the word Wⱼ is “XYZ124”, then the distance between word Wᵢ and word Wⱼ can be computed as 1. At operation 1605, the method 1600 includes assigning scores based on length of words and some heuristics. In response to determining that the word Wᵢ and the word Wⱼ are matched, the score for that particular comparison can be assigned based on length of the words and some heuristics. For example, if the word W₁ from the tokenized string S₁ and the word W₁ from the tokenized string S₂ are matching, then a high score to the comparison can be assigned. Similarly, if word W₂ from tokenized string S₁ and word W₂ from tokenized string S₂ are matching, then the method assigns a score that is less than the score assigned for comparison between first words of tokenized strings.

At operation 1606, the method 1600 includes converting either the assigned score for the comparison or the computed score into a probability value. At operation 1607, the method 1600 includes selecting either the word Wᵢ or the word Wⱼ using either assigned score for the comparison or the computed score. Similarly, the method 1600 includes repeating the operations 1601 to 1607 for each word of the tokenized strings S₁ and each word of the tokenized strings S₂. Further, at operation 1608, the method 1600 includes computing computes combined probability value of text similarity between the tokenized string S₁ and the tokenized string S₂. The combined probability value (Prₛ) between the tokenized strings S₁ and the tokenized string S₂ is given as Equation (2) below:

$${Pr}_{s} = \frac{( 1 - {Pr}_{{ww}^{1} 1} ) + ( 1 - {Pr}_{{ww}^{1} 2} ) + … + ( 1 - {Pr}_{{ww}^{1} i} )}{\begin{matrix}Minimum number of words \\ from strings {S}_{1}^{1} and {S}_{2}^{1}\end{matrix} } \qquad Equation ( 2 )$$

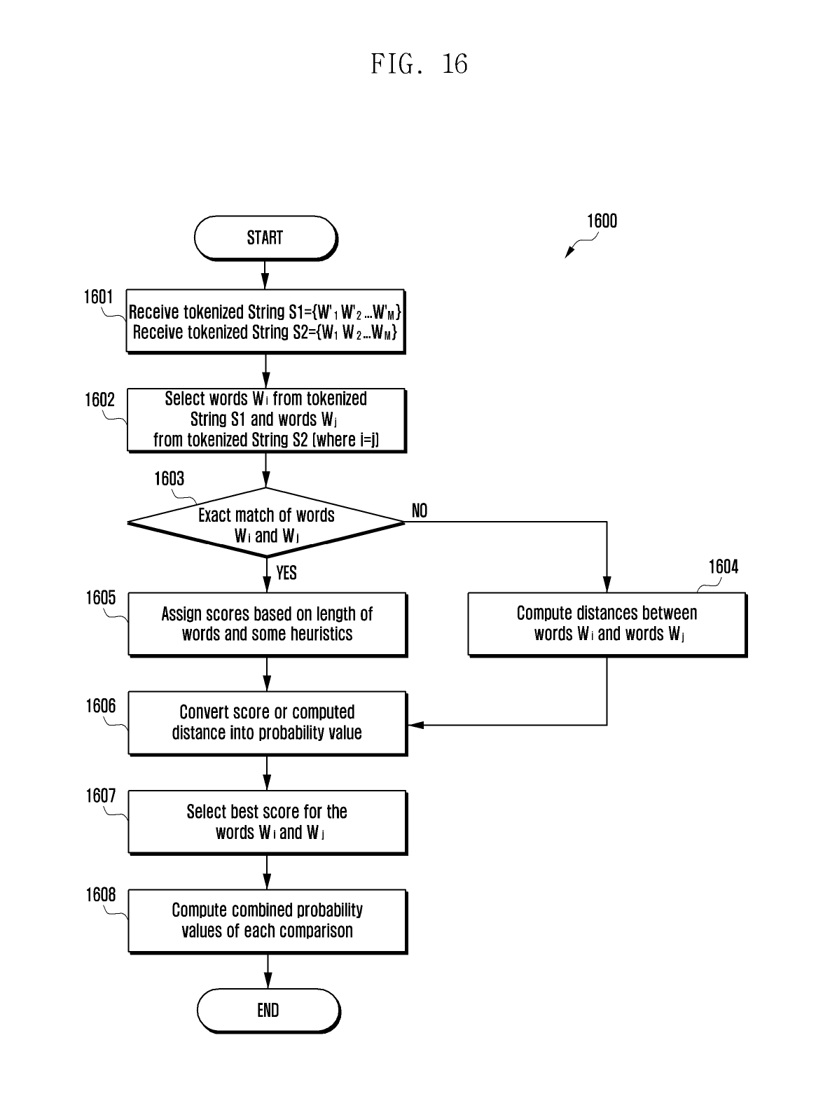

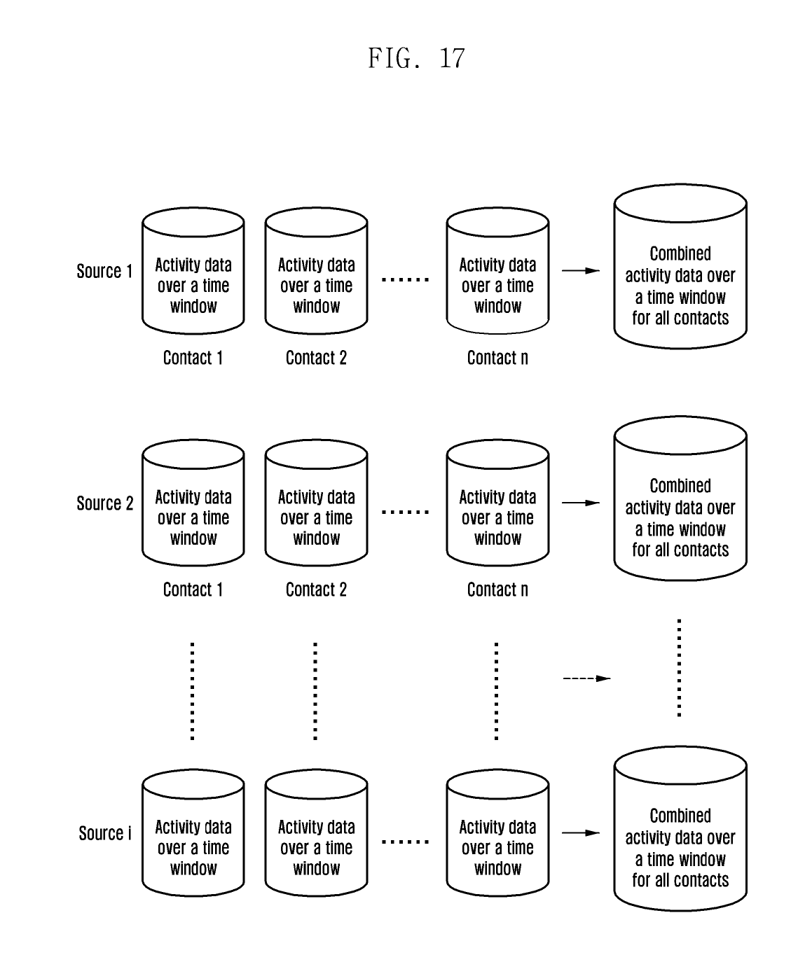

FIG. 17 illustrates an overview of obtaining social media updates and interaction data between owner and user contacts obtained from various data sources according to an embodiment of the present disclosure.

Referring to FIG. 17, a combined activity data for each data source 102 is generated by obtaining various social media updates or social activities performed by each contact over a time window. For example, combined activity data generated by the source-1 over a time window is combination of social activities performed by the contact-1, the contact-2 and the like from the source-1 over the time window. The various social activities may include for example, but are not limited to, sending emails, receiving emails, tweets, retweets, sharing photos or videos, comments on posts or photos or videos, likes, endorsements, recommendations, and the like.

In an embodiment of the present disclosure, the contacts of the user are ranked based on time duration since, not all contacts may necessarily be of equal importance at a given time. The number and type of social activities performed by contacts of the user may vary from one time duration to other time duration. For example, for a time period of 10 days, number and type of social activities performed by at least one contact may be different from the number and type of social activities performed by the at least one contact in 50 days.

FIG. 18 is a flow diagram illustrating a method for organizing contact profiles into one or more groups according to an embodiment of the present disclosure.

Referring to FIG. 18, at operation 1801, the method 1800 includes identifying activities performed by at least one of owner and contact. At operation 1802, the method 1800 includes assigning a weight to each identified activity performed by the owner and the contacts. The weight described herein can be dynamically assigned based on an analysis of type of activity over the time window. At operation 1803, the method 1800 includes computing a degree of involvement of each contact based on the identified activities over the time window. The method 1800 allows the ranking module 101f to compute the degree of involvement of each contact based on the identified activity performed by the owner and the associated contacts over a time window. Appending the weight of each activity associated with the contact to compute the degree of involvement.

At operation 1804, the method 1800 includes ranking the contact in accordance to the computed degree of involvement. At operation 1805, the method 1800 includes frequently monitoring the activities of the contacts associated with various data sources 102. The method 1800 allows the ranking module 101f to periodically monitor the activities performed by the user on the data items of the contact profile. At operation 1806, the method 1800 includes repeating the operations 1801 to 1805 in response to determining any changes performed on the data items of the contacts.

FIG. 19 is a flow diagram illustrating a method for ranking contacts based on weighted activity score according to an embodiment of the present disclosure.

In an embodiment of the present disclosure, different activities performed by the owner and the contacts can be used to rank the contacts at a given time. The activity and timing of the social activities associated with each contact and the owner can be major data items in determining the ranks. Other factors can include, for example, type of activity, identity of contact, the relationship of a contact with the owner of the electronic device.

A numerical value or a weightage of each activity can be computed, such as to compute the degree of involvement of each contact. The assigned weight can be dynamically changed based on the type of activity and who initiated the activity. For example, the contact who initiates the activity may be assigned more weight than the other contacts participated. Each type of the activity has dynamically changing weights depending on the interaction analysis of that type of the activity at a given time.

An option to the owner of the electronic device 101 can be provided to assign desired weights for each type of activity. Based on the assigned weights the ranking module 101f can be configured to compute the degree of involvement of each contact.

Referring to FIG. 19, the combined social activities data of the owner and contacts from 1 to n are stored in a database. At operation 1901, the method includes identifying the activities performed by the owners and contact over a time window. A weight to each identified activity performed by the owner and the contacts are assigned. The weight described herein can be dynamically assigned based on an analysis of type of activity over the time window. As shown, for a contact ‘j’, sum of sharing activity over a given time period is computed as a₁ⱼ, sum of email exchange activity is computed as a₂ⱼ, sum of chatting activity over a given time period is a₃ⱼ and similarly sum of ‘ i^{th}’ over a given time period is computed as aᵢⱼ. The weights W₁ is assigned to sharing activity, weight W₂ is assigned for email exchange activity, weight W₃ is assigned for chatting activity.

At operation 1902, the method 1900 includes computing a degree of involvement of each contact biased on the identified activities over the time window. The method 1900 allows the ranking module 101f to compute the degree of involvement of each contact based on the identified activity performed by the owner and the associated contacts over a time window.

In an embodiment of the present disclosure, Equation (3) below can be used to compute the degree of involvement of each contact ‘j’ based on the activities performed:

$${S}_{j} ( t ) = ( 1 - α ) {S}_{j} ( t - 1 ) + α {\sum }_{i} {w}_{ij} {a}_{ij} \\ {S}_{j} ( t ) = {S}_{j} ( t - 1 ) + \sum {W}_{i} {A}_{ij} \qquad Equation ( 3 )$$

where, Sⱼ(t) is the degree of involvement for a given time ‘t’, Sⱼ(t−1) is the total weighted activity score of a prior social activities performed by ‘j’th contact,

$${\sum }_{i} {W}_{ij} {A}_{ij}$$

is current score at time t and α is a smoothing factor which lies between 0 and 1.

At operation 1903, the method 1900 includes ranking the contact in accordance to the computed degree of involvement. The method 1900 allows the ranking module 101f to rank the contacts based on the degree of involvement.

In addition to this, the method 1900 includes automatically updating ranking of each contact based on the updates or other activities performed by the owner and the contact. For example, if a new activity is performed by a contact then the degree of involvement for the corresponding contact is updated, and rankings are generated based on updated degree of involvement of each contact.

In an embodiment of the present disclosure, contacts that are ranked are presented to the user on the output interface 101i. In another embodiment of the present disclosure, the user may be further presented with a means to navigate to the favorite contacts in a hierarchical manner using the favorite contacts that are displayed. Upon presenting the contacts in the order of importance, the user is provided with an option to revise contacts order. All the social activities performed by favorite contacts are provided to the user in the order of their importance.

The methods, and other description described herein provide a basis for a control program, which can be implemented using a microprocessor, a microcontroller, or an equivalent thereof. Further, the various actions, units, operations, blocks, or acts described in the methods can be performed in the order presented, in a different order, simultaneously, or a combination thereof. Further, in some various embodiments, some of the actions, units, operations, blocks, or acts listed in the FIGS. 7, 8, 9, 10, 11, 12, 13, 14, 15, 16, 18, and 19 may be omitted, added, skipped, or modified without departing from the scope of the present disclosure.

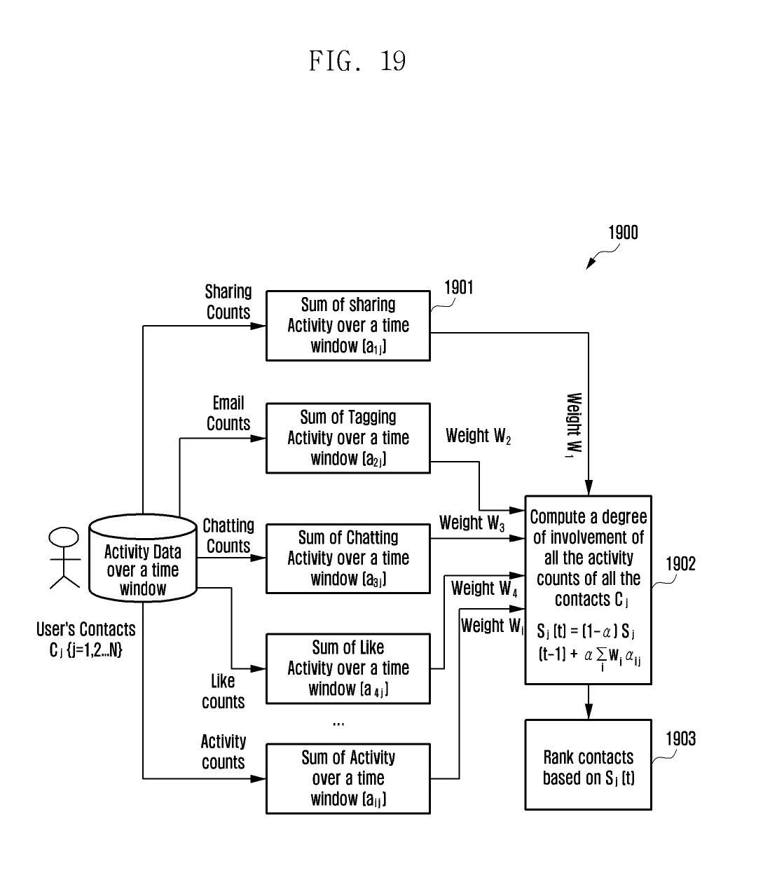

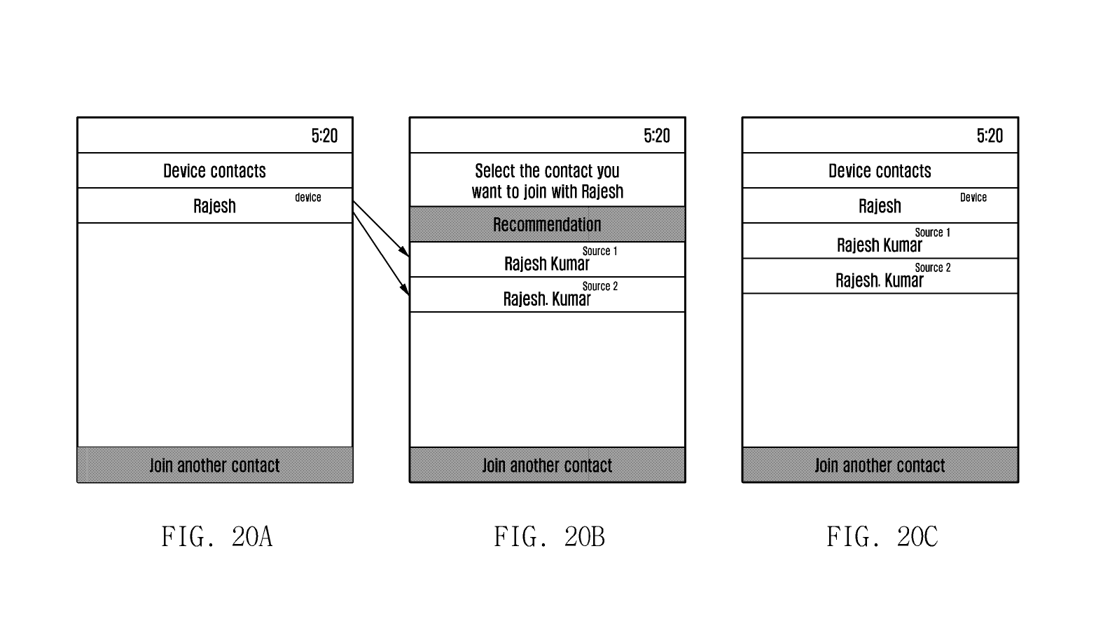

FIGS. 20A, -20B, and 20C illustrate pairing contact profiles obtained from various data sources according to an embodiment of the present disclosure.

Referring to FIG. 20A, a contact named “Rajesh” in the electronic device 101 is illustrated. Assume that the user of the electronic device 101 has user has contacts in the contacts list form the data source-1 and data source-2. If the user wish to sync the device contact named “Rajesh” with the contacts from the data source-1 and the data source-2, then the synching module can determine the degree of similarity of the contact “Rajesh” with the contacts of the data source-1 and the data source-2 using the data items associated with the contact “Rajesh”.

Referring to FIG. 20B, the synching module may provide recommendations to synch the contact “Rajesh” with the contacts from the data source-1 and the data source-2. For example, the two identified contact profiles named “Rajesh Kumar” and “Rajesh.kumar” from the fused contact profile data are provided as recommends to the user for syncing.

Referring to FIG. 20C, the electronic device contact named “Rajesh” is paired up with recommended contacts. The synching module is used to automatically synch the contact in response to receiving a confirmation from the user of the electronic device 101.

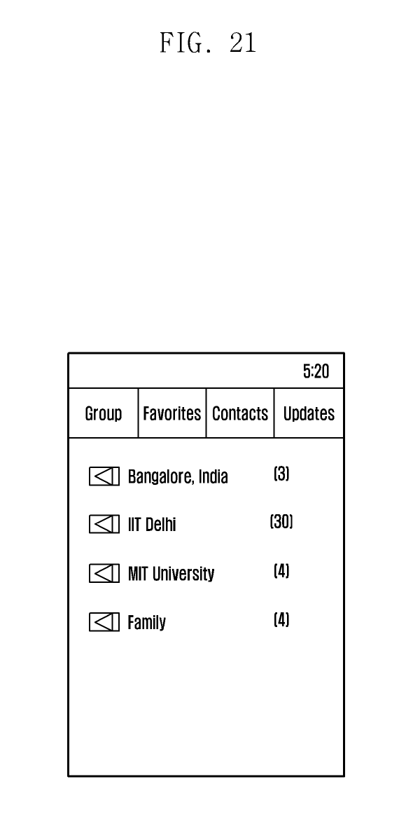

FIG. 21 illustrates groups of data items including contacts obtained from various data sources according to an embodiment of the present disclosure.

Referring to FIG. 21, the groups of data items obtained are created based on the degree of similarity between the data item of the owner and the data item of the contact. As shown in the FIG. 21, list of all groups, such as “Bangalore India”, “IIT Delhi”, “MIT University” and “Family” including the contacts from various data sources are displayed to the owner of the electronic device 101.

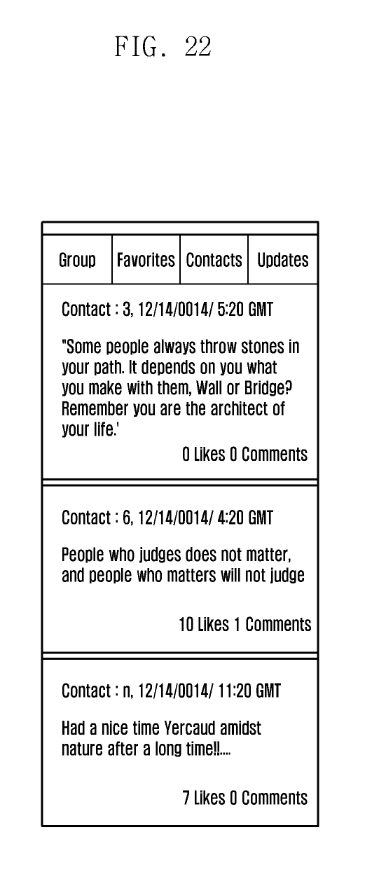

FIG. 22 illustrates activities displayed in accordance to ranks of a contact according to an embodiment of the present disclosure.

Referring to FIG. 22, the degree of involvement of each contact is computed based on the identified activity performed by the owner and the associated contacts over the time window. Further, ranks to each contact are provided in accordance to the computed degree of involvement. The activities of the contacts can be sorted based on the rank associated with the contact. In an embodiment of the present disclosure, the feed of the user can be sorted by displaying the highest ranked contact activities first followed by other sub-sequent ranked contacts activities. For example, as shown in the FIG. 22, the activities associated with the contact-3 can be displayed first followed with the activities of the contact-6 and contact-n in accordance to the ranks associated with the contacts.

Thought the above description is described with respect to contacts associated with various data sources but, it is to be understood other various embodiments are not limited thereto. The proposed system and methods as a framework for applications where data associated with various sources need to be synched, organized, and ranked. For example, the system and methods can be used to sync, organize, and rank the same or similar products from various vendors and manufactures. In another example, the system and methods can be used to sync, organize, and rank employees or members belonging to different departments in an organization but, possess similar or similar skills.

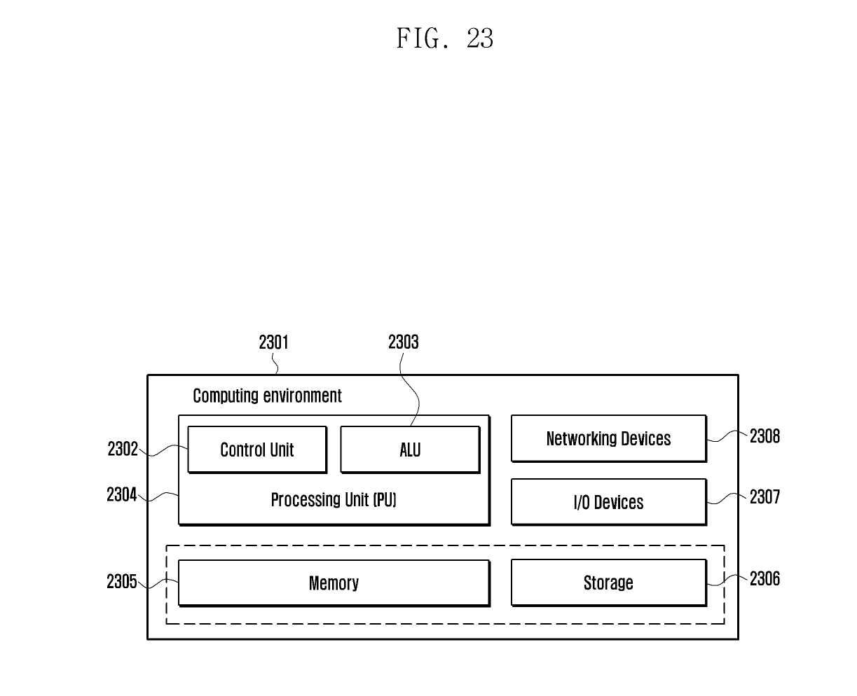

FIG. 23 illustrates a computing environment implementing a method and a system for synchronizing, organizing, ranking contacts in an electronic device according to an embodiment of the present disclosure.

Referring to FIG. 23, the computing environment 2301 comprises at least one Processing Unit (PU) 2304 that is equipped with a control unit 2302 and an Arithmetic Logic Unit (ALU) 2303, a memory 2305, a storage unit 2306, a clock chip 4, plurality of networking devices 2308, and a plurality Input Output (I/O) devices 2307. The processing unit 2304 is responsible for processing the instructions of the algorithm. The processing unit 2304 receives commands from the control unit 2302 in order to perform its processing. Further, any logical and arithmetic operations involved in the execution of the instructions are computed with the help of the ALU 2303.

The overall computing environment 2301 may include multiple homogeneous and/or heterogeneous cores, multiple CPUs of different kinds, special media and other accelerators. The processing unit 2304 is responsible for processing the instructions of the algorithm. The processing unit 2304 receives commands from the control unit 2302 in order to perform its processing. Further, any logical and arithmetic operations involved in the execution of the instructions are computed with the help of the ALU 2303. Further, the plurality of process units may be located on a single chip or over multiple chips.

The algorithm comprising of instructions and codes required for the implementation are stored in either the memory unit 2305 or the storage 2306 or both. At the time of execution, the instructions may be fetched from the corresponding memory 2305 and/or storage 2306, and executed by the processing unit 2304. The processing unit 2304 synchronizes the operations and executes the instructions based on the timing signals generated by the clock chip.

The various embodiments disclosed herein can be implemented through at least one software program running on at least one hardware device and performing network management functions to control the elements. The elements, blocks, operations, acts, and operations shown in FIGS. 1 through 23 include blocks which can be at least one of a hardware device, or a combination of hardware device and software module.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for computing a degree of similarity among a plurality of contacts of a user associated with a plurality of data sources, the method comprising:
identifying at least one data item associated with each contact from the plurality of data sources, wherein each data item comprises at least one of an attribute, and a sub-attribute; and
computing a degree of similarity between each contact of the user and each other contact of the user using the at least one identified data item.

2. The method of claim 1, further comprising:
determining whether the degree of similarity for each item exceeds a threshold; and
performing at least one action in response to determining that the degree of similarity of each contact exceeds the threshold.

3. The method of claim 2, wherein the at least one action comprises at least one of providing at least one recommendation to sync the at least one contact of the user, and automatically synching the at least one contact of the user.

4. The method of claim 1, wherein each data item is associated with at least one weight, wherein the weight is one of a static weight and a dynamic weight.

5. The method of claim 4, wherein the weight is associated with each data item according to a correlation between the at least one data item and the contact of the user.

6. The method of claim 1, wherein the computing of the degree of similarity between each item associated with the at least one data source and each other contact using the at least one identified data item further comprises:
determining a matching probability for each data item of each contact with each other data item of each other contact, wherein each data item is associated with a data item type;
computing a weightage for each data item by multiplying the matching probability with the dynamic weight associated with the data item;
determining whether the weightage for each data item exceeds a data item threshold; and
appending the weightage of each data item to compute the degree of similarity for the contact of the user in response to determining that the weightage for each data item exceeds the data item threshold.

7. The method of claim 6, wherein the at least one data item type comprises a priority data item type.

8. The method of claim 1, further comprising:
displaying the at least one recommended contact of the user associated with the at least one data source;
receiving a confirmation to sync the at least one recommended contact of the user with the at least one other contact; and
synching the at least one recommended contact of the user with the at least one other contact in response to receiving the confirmation.

9. The method of claim 1, further comprising:
frequently monitoring the at least one data item associated with each contact; and
updating the at least one data item based on the monitoring.

10. The method of claim 1, further comprising:
storing the at least one data item associated with the plurality of synched contacts of the user; and
fusing the at least one data item associated with the plurality of synched contacts of the user.

11. A method for dynamically organizing at least one contact of a user associated with a plurality of data sources, the method comprising:
identifying at least one data item associated with each contact from the plurality of data sources, wherein each data item comprises at least one of an attribute, and a sub-attribute;
computing a degree of similarity between the at least one data item associated with the user and the at least one other data item associated with each contact;
determining whether the degree of similarity for each data item exceeds a data item threshold; and
organizing the at least one contact into a group of the data item in response to determining that the degree of similarity for each data item exceeds the data item threshold.

12. The method of claim 11, further comprising:
frequently monitoring the at least one data item associated with each contact; and
updating the at least one data item based on the monitoring.

13. The method of claim 11, further comprising:
storing the at least one data item associated with each contact of the user; and
fusing the at least one data item associated with each contact of the user.

14. A method for dynamically ranking at least one contact of a user associated with a plurality of data sources, the method comprising:
identifying at least one activity performed by at least one of the at least one contact and the user;
computing a degree of involvement of each contact based on the at least one identified activity over a time window; and
ranking the at least one contact in accordance to the degree of involvement.

15. The method of claim 14, wherein the computing of the degree of involvement of the at least one contact based on the at least one identified activity over the time window further comprises:
assigning a weight to each identified activity performed by each contact, wherein the weight is dynamically changed based on an analysis of type of activity over the time window; and
appending the weight of each activity associated with each contact to compute the degree of involvement of the at least one contact and the user.

16. The method of claim 15, wherein the weight is associated with each activity according to a correlation between the at least one contact and the user.

17. The method of claim 14, further comprising:
frequently monitoring the at least one data item associated with each contact; and
updating the at least one data item based on the monitoring.

18. The method of claim 14, further comprising:
storing the at least one data item associated with each contact of the user; and
fusing the at least one data item associated with each contact of the user.

19. A system for computing a degree of similarity among a plurality of contacts of a user associated with a plurality of data sources, the system comprising:
a synchronization module configured:
to identify at least one data item associated with each contact from the plurality of data sources, where each data item comprises at least one of an attribute, and a sub-attribute, and
to compute a degree of similarity between each contact of the user and each other contact of the user using the at least one identified data item.

20. The system of claim 19, wherein the synchronization module is further configured:
to determine whether the degree of similarity for each item exceeds a threshold, and
to perform at least one action in response to determining that the degree of similarity of each contact exceeds the threshold.

21. The system of claim 20, wherein the at least one action comprises at least one of providing at least one recommendation to sync the at least one contact of the user, and automatically synching the at least one contact of the user.

22. The system of claim 19, wherein each data item is associated with at least one weight, wherein the weight is one of a static weight and a dynamic weight.

23. The system of claim 22, wherein the weight is associated with each data item according to a correlation between the at least one data item and the contact of the user.

24. The system of claim 19, wherein the synchronization module is further configured:
to determine a matching probability for each data item of each contact with each other data item of each other contact, wherein each data item is associated with a data item type,
to compute a weightage for each data item by multiplying the matching probability with the dynamic weight associated with the data item,
to determine whether the weightage for each data item exceeds a data item threshold, and
to append the weightage of each data item to compute the degree of similarity for the contact of the user in response to determining that the weightage for each data item exceeds the data item threshold.

25. The system of claim 24, wherein the at least one data item type comprises a priority data item type.

26. The system of claim 19, wherein the synchronization module is further configured:
to display the at least one recommended contact of the user associated with the at least one data source,
to receive a confirmation to sync the at least one recommended contact of the user with the at least one other contact, and
to sync the at least one recommended contact of the user with the at least one other contact in response to receiving the confirmation.

27. The system of claim 19, wherein the synchronization module is further configured:
to frequently monitor the at least one data item associated with each contact, and
to update the at least one data item based on the monitoring.

28. The system of claim 19, wherein the synchronization module is further configured:
to store the at least one data item associated with the plurality of synched contacts of the user, and
to fuse the at least one data item associated with the plurality of synched contacts of the user.

29. A system for dynamically organizing at least one contact of a user associated with a plurality of data sources, the system comprising:
a synchronization module configured:
to identify at least one data item associated with each contact from the plurality of data sources, wherein each data item comprises at least one of an attribute, and a sub-attribute,
to compute a degree of similarity between the at least one data item associated with the user and the at least one other data item associated with each contact,
to determine whether the degree of similarity for each data item exceeds a data item threshold, and
to organize the at least one contact into a group of the data item in response to determining that the degree of similarity for each data item exceeds the data item threshold.

30. The system of claim 29, wherein the synchronization module is further configured:
to frequently monitor the at least one data item associated with each contact, and
to update the at least one data item based on the monitoring.

31. The system of claim 29, wherein the synchronization module is further configured:
to store the at least one data item associated with each contact of the user, and
to fuse the at least one data item associated with each contact of the user.

32. A system for dynamically ranking at least one contact of a user associated with a plurality of data sources, the system comprising:
a synchronization module configured:
to identify at least one activity performed by at least one of the at least one contact and the user,
to compute a degree of involvement of each contact based on the at least one identified activity over a time window, and
to rank the at least one contact in accordance to the degree of involvement.

33. The system of claim 32, wherein the synchronization module is further configured:
to assign a weight to each identified activity performed by each contact, wherein the weight is dynamically changed based on an analysis of type of activity over the time window, and
to append the weight of each activity associated with each contact to compute the degree of involvement of the at least one contact and the user.

34. The system of claim 33, wherein the weight is associated with each activity according to a correlation between the at least one contact and the user.

35. The system of claim 32, wherein the synchronization module is further configured:
to frequently monitor the at least one data item associated with each contact, and
to update the at least one data item based on the monitoring.

36. The system of claim 32, wherein the synchronization module is further configured:
to store the at least one data item associated with each contact of the user, and
to fuse the at least one data item associated with each contact of the user.

37. A computer program product comprising computer executable program code recorded on a computer readable non-transitory storage medium, the computer executable program code when executed, causing the actions including:
identifying at least one data item associated with each contact from a plurality of data sources, wherein each data item comprises at least one of: an attribute, and a sub-attribute; and
computing a degree of similarity between each contact of the user and each other contact using the at least one identified data item.
